(19) United States
(12) Patent Application Publication
(10) Pub. No.: US 2023/0283120 A1
(43) Pub. Date: Sep. 7, 2023

(54) ELECTRONIC DEVICE AND METHOD FOR PROVIDING WIRELESS CHARGING GUIDANCE BY ELECTRONIC DEVICE

(71) Applicant: SAMSUNG ELECTRONICS CO., LTD., Suwon-si (KR)

(72) Inventors: Jaesung LEE, Suwon-si (KR); Inmyung WOO, Suwon-si (KR); Juhyang LEE, Suwon-si (KR); Jaemu HA, Suwon-si (KR)

(73) Assignee: SAMSUNG ELECTRONICS CO., LTD., Suwon-si (KR)

(21) Appl. No.: 18/129,603

(22) Filed: Mar. 31, 2023

Related U.S. Application Data
(63) Continuation of application No. PCT/KR2021/009966, filed on Jul. 30, 2021.

(30) Foreign Application Priority Data
Oct. 8, 2020 (KR) 10-2020-0129832

(51) Int. Cl. H02J 50/90; H02J 50/80; H02J 50/10; H04B 5/00

(52) U.S. Cl. CPC H02J 50/90; H02J 50/10; H02J 50/80; H04B 5/0037

(57) ABSTRACT

An electronic device includes: a wireless power reception circuit; a communicator; and at least one processor operatively connected to the wireless power reception circuit and the communicator, wherein the at least one processor is configured to: control, based on initiation of wireless charging of the electronic device, power input from an external device to the electronic device via the wireless power reception circuit; transmit, to the external device via a designated communication scheme, first information corresponding to the power input to the electronic device from the external device; receive, from the external device via an out-band communication scheme through the communicator, second information that corresponds to a charging efficiency of the electronic device; and provide, based on the second information, a location change notification for the electronic device.

### CROSS-REFERENCE TO RELATED APPLICATIONS

This application is a by-pass continuation of International Application No. PCT/KR2021/009966, filed on Jul. 30, 2021, which is based on and claims priority to Korean Patent Application No. 10-2020-0129832, filed on Oct. 8, 2020, in the Korean Intellectual Property Office, the disclosures of which are incorporated by reference herein in their entireties.

### BACKGROUND

### 1. Field

The disclosure relates to a method and apparatus for providing a guide related to wireless charging of an electronic device in an electronic device capable of performing wireless charging.

### 2. Description of Related Art

As wireless charging technology has become more widely used, wireless charging sharing technology is being developed that charges another electronic device by using an electronic device that is different from a dedicated wireless charger (e.g., a charging pad). An electronic device may support wireless charging using wireless charging technology (or wireless power transfer technology). According to the wireless power transfer technology, power may be transferred from a transmission device to a reception device in a wireless manner without a connection via a separate connector between electronic devices, for example, an electronic device may supply power (e.g., a transmission device) and an electronic device may receive power (e.g., a reception device) in a wireless manner, and a battery of the reception device may be charged. The wireless power transfer technology may include a magnetic induction scheme and a magnetic resonance scheme, and may include other various types of wireless power transfer technologies.

To transmit power using wireless power transfer technology, a reception device may be placed on a transmission device (e.g., putting them in close contact such as placing a reception device on a transmission device). For example, a reception coil (or a charging coil) of the reception device may be disposed in a direction (the backside or rear direction of the electronic device) that faces a direction in which a transmission coil (or a charging coil) of the transmission device is disposed.

The charging efficiency of wireless power transfer may differ according to a positional relationship between a transmission coil and a reception coil. For example, when the center of the transmission coil and the center of the reception coil are disposed to correspond to each other, peak charging efficiency may be provided. When the center of the transmission coil and the center of the reception coil do not match, the charging efficiency may deteriorate or it may happen that charging is not allowed due to heat generated.

However, the locations of the transmission coil of the transmission device and the reception coil of the reception device are not exposed to the outside, and thus a user may have difficulty in accurately recognizing a spot of the transmission device where high charging efficiency is provided when the reception device is placed on the transmission device. In addition, even though charging efficiency between the transmission device and the reception device is low, a user may be difficult to recognize the same.

Between a transmission device and a reception device, data (e.g., charging-related data) required for controlling transmission or reception of power may be transmitted or received. For example, according to the wireless power consortium (WPC) standard, an in-band communication scheme that performs data communication (e.g., data transmission or reception) using a part (e.g., a frequency identical to that of wireless power transmission) of a frequency band used for transmitting or receiving power in a wireless manner may be used. The in-band communication scheme may transmit or receive data via a coil used for transmitting or receiving power in a wireless manner.

However, a frequency bandwidth used for the in-band communication scheme may be relatively narrower than a frequency bandwidth used for other communication schemes (e.g., an out-band communication scheme) and a data transmission speed may be low, and thus data transmission or reception may not be smoothly performed. Generally, wireless charging technology may use the in-band communication scheme, but the in-band communication scheme has a low communication speed and low communication safety and thus may operate to enable a transmission device and a reception device to exchange only simple information therebetween.

### SUMMARY

Provided are a method and apparatus for providing a guide related to wireless charging of an electronic device in an electronic device capable of performing wireless charging.

Further, provided are a method and apparatus for performing wireless charging based on in-band communication between an electronic device (e.g., a transmission device) that supplies power and an electronic device (e.g., a reception device) that receives power in a wireless manner, and for providing information associated with guidance about a location for charging the reception device according to the out-band communication when wireless charging is performed.

Further still, provided are a method and apparatus for obtaining, by a reception device, information (e.g., charging efficiency) related to a charging state from a transmission device via out-band communication, and determining whether misalignment occurs based on the obtained information, when wireless charging is performed between the transmission device and the reception device via in-band communication.

Further still, provided are a method and apparatus for providing, based on a result obtained when the reception device determines whether misalignment occurs, a notification associated with misalignment according to a designated scheme.

Additional aspects will be set forth in part in the description which follows and, in part, will be apparent from the description, or may be learned by practice of the presented embodiments.

According to an aspect of the disclosure, an electronic device includes: a wireless power reception circuit; a communicator; and at least one processor operatively connected to the wireless power reception circuit and the communicator, wherein the at least one processor is configured to: control, based on initiation of wireless charging of the electronic device, power input from an external device to the electronic device via the wireless power reception circuit; transmit, to the external device via a designated communication scheme, first information corresponding to the power input to the electronic device from the external device; receive, from the external device via an out-band communication scheme through the communicator, second information that corresponds to a charging efficiency of the electronic device; and provide, based on the second information, a location change notification for the electronic device.

The at least one processor may be further configured to: produce, based on the power input from the external device, the first information related to charging, the designated communication scheme may include an in-band communication scheme or the out-band communication scheme, and the first information may include control data corresponding to at least one of a received power packet (RPP) or a control error packet (CEP).

The at least one processor may be further configured to: activate, based on a state of the communicator, the communicator when initiating the wireless charging or transmitting the first information; and establish, via the communicator, a communication channel for the out-band communication scheme with the external device.

The second information may include the charging efficiency of the electronic device, the second information is determined by the external device, the second information is based on a ratio of power received by the electronic device to power transmitted by the external device, and the power received by the electronic device is identified based on the first information.

The at least one processor may be further configured to: compare a first charging efficiency based on the second information and a second charging efficiency set for the electronic device; based on a difference between the first charging efficiency and the second charging efficiency, determine whether alignment or misalignment occurs; based on determining that alignment occurs, provide a first guide related to wireless charging; and based on determining that misalignment occurs, provide a second guide related to location alignment.

The at least one processor may be further configured to, based on determining that misalignment occurs, provide a notification for a degree of misalignment corresponding to a degree of the difference between the first charging efficiency and the second charging efficiency.

The at least one processor is configured to: determine, based on the difference between the first charging efficiency and the second charging efficiency, whether the first charging efficiency is within a predetermined range; based on determining that the first charging efficiency is within the predetermined range, determine that alignment occurs and provide a notification related to wireless charging via an output module of the electronic device; and based on determining that the first charging efficiency is outside of the predetermined range, determine that misalignment occurs and provide the location change notification via the output module.

The in-band communication scheme may include communication via a wireless power signal between a coil of the electronic device and a coil of the external device, and the out-band communication scheme may include a short-range wireless communication scheme different from the in-band communication scheme.

According to an aspect of the disclosure, an operation method of an electronic device, includes: receiving, based on initiation of wireless charging of the electronic device, power from an external device via a wireless power reception circuit; transmitting, to the external device via a designated communication scheme, first information corresponding to the power received by the electronic device from the external device; receiving, from the external device via an out-band communication scheme using a communicator of the electronic device, second information corresponding to a charging efficiency of the electronic device; and providing, based on the second information, a location change notification for the electronic device.

The operation method may further include: producing, based on the power received from the external device, the first information related to charging, the designated communication scheme may include an in-band communication scheme or the out-band communication scheme, and the first information may include control data corresponding to a received power packet (RPP) or a control error packet (CEP).

The operation method may further include: activating, based on a state of the communicator, the communicator when initiating the wireless charging or transmitting the first information; and establishing, via the communicator, a communication channel for the out-band communication scheme with the external device, the in-band communication scheme may include communication via a wireless power signal between a coil of the electronic device and a coil of the external device, and the out-band communication scheme may include a short-range wireless communication scheme different from the in-band communication scheme.

The second information may include the charging efficiency of the electronic device, the second information may be determined by the external device, the second information may be based on a ratio of power received by the electronic device to power transmitted from the external device, and the power received by the electronic device may be identified based on the first information.

The providing the location change notification may include: comparing a first charging efficiency based on the second information and a second charging efficiency set for the electronic device; determining, based on a difference between the first charging efficiency and the second charging efficiency, whether alignment or misalignment occurs; based on determining that alignment occurs, providing a first guide related to wireless charging; and based on determining that misalignment occurs, providing a second guide related to location alignment.

The providing the location change notification may further include, based on determining that misalignment occurs, providing a notification for a degree of misalignment corresponding to a degree of the difference between the first charging efficiency and the second charging efficiency.

The providing the location change notification may further include: determining, based on the difference between the first charging efficiency and the second charging efficiency, whether the first charging efficiency is within a predetermined range; based on determining that the first charging efficiency is within the predetermined range, determining that alignment occurs and providing a notification related to wireless charging via an output module of the electronic device; and based on determining that the first charging efficiency is outside of the predetermined range, determining that misalignment occurs and providing the location change notification via the output module.

According to an electronic device and an operation method thereof according to various embodiments, a reception device may provide a location for alignment for wireless charging to a user so as to increase efficiency of wireless charging when wireless power transfer is performed by a transmission device. According to various embodiments, guidance is provided to a user so that a transmission device and a reception device perform wireless charging in a location where they mutually support peak charging efficiency, and thus stable wireless charging between the transmission device and the reception device may be supported. According to various embodiments, based on data communication using out-band communication, data may be stably transmitted and a data transmission speed may also be increased.

According to various embodiments, a transmission device calculates substantial charging efficiency in consideration of efficiency of the transmission device and efficiency of a reception device, and provides the same to the reception device via out-band communication. The reception device may determine, based on the substantial charging efficiency, whether misalignment occurs and may provide a related guide. According to various embodiments, by taking into consideration efficiency of both a transmission device and a reception device, the transmission device may decrease battery consumption and also the reception device may have optimal charging efficiency. According to various embodiments, an accurate (or detailed) positioning guide may be provided to a user by providing a guide for each level of misalignment to the user. According to various embodiments, a charging-enabled area may be divided narrowly, a charging speed may be improved since heat is less generated than before if charging is performed at a location that shows peak efficiency, and battery consumption of a transmission device may be reduced since charging efficiency is improved.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an example electronic device in a network environment according to various embodiments;

FIG. 2 is a diagram illustrating an electronic device and an external device that supplies power to an electronic device in a wireless manner according to various embodiments;

FIG. 3 is a diagram illustrating a communication channel used for data transmission and reception between an electronic device and an external device according to various embodiments;

FIG. 4 is a diagram illustrating an operation of performing communication between an electronic device and an external device according to various embodiments;

FIG. 5A is a diagram illustrating charging efficiency based on the degree of alignment between an electronic device and an external device according to an embodiment;

FIG. 5B is a diagram illustrating charging efficiency based on the degree of alignment between an electronic device and an external device according to an embodiment;

FIG. 5C is a diagram illustrating charging efficiency based on the degree of alignment between an electronic device and an external device according to an embodiment;

FIG. 5D is a diagram illustrating charging efficiency based on the degree of alignment between an electronic device and an external device according to an embodiment;

FIG. 6 is a diagram illustrating an operation of performing communication between an electronic device and an external device according to various embodiments;

FIG. 7 is a flowchart illustrating an operation method of an electronic device according to various embodiments;

FIG. 8 is a flowchart illustrating an operation method of an electronic device according to various embodiments;

FIG. 9 is a diagram illustrating an example of providing a notification by an electronic device according to various embodiments;

FIG. 10 is a flowchart illustrating an operation method of an external device according to various embodiments;

FIG. 11 is a diagram illustrating an example of providing a notification and a charging operation performed between an electronic device and an external device according to an embodiment;

FIG. 12 is a diagram illustrating an example of providing a notification and a charging operation performed between an electronic device and an external device according to an embodiment; and

FIG. 13 is a diagram illustrating an example of providing a notification and a charging operation performed between an electronic device and an external device according to an embodiment.

### DETAILED DESCRIPTION

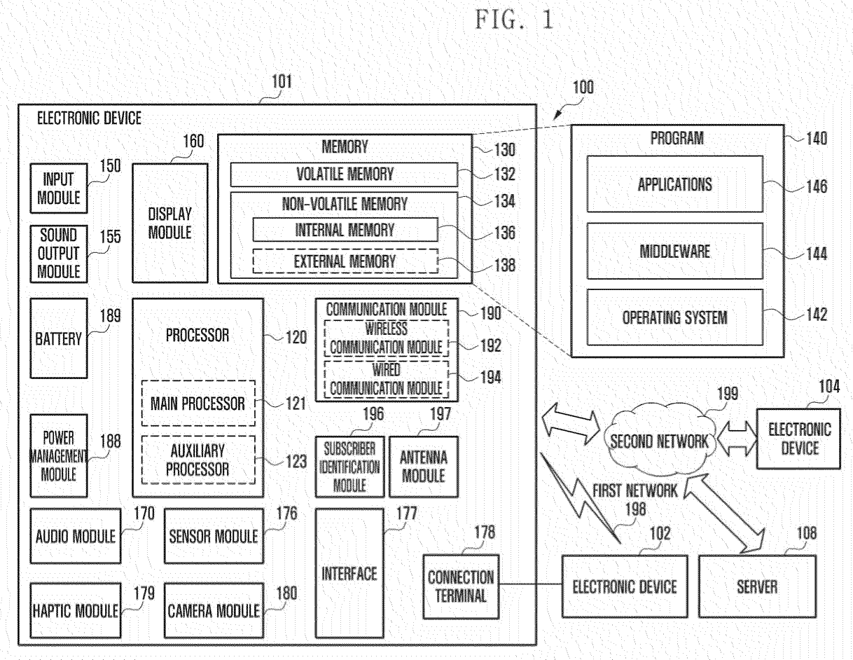

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

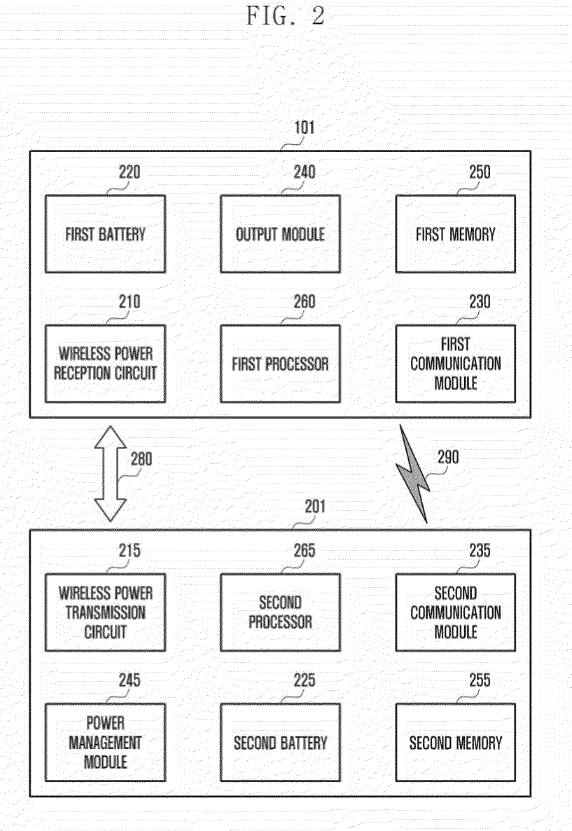

FIG. 2 is a diagram illustrating an electronic device and an external device that supplies power to an electronic device in a wireless manner according to various embodiments.

According to an embodiment, the electronic device 101 (e.g., or the first electronic device 101) may include various types of devices supporting a wireless charging function that receives power from the external device 201 (or the second electronic device 201) in a wireless manner and is capable of charging a battery (e.g., the first battery 220 of FIG. 2) of the electronic device 101. For example, the electronic device 101 may include a wearable device and/or a smartphone. According to an embodiment, the wearable device may include various types of devices such as a watch (e.g., a smart watch), wireless earphones, and/or a wireless headset. The electronic device 101 according to an embodiment of the disclosure is not limited to the above-described devices, and the electronic device 101 may correspond to various types of devices capable of receiving wireless power and performing wireless charging. According to an embodiment, the electronic device 101 may operate as a power transmission device that transmits wireless power to the external device 201 according to a wireless charging mode (e.g., a wireless power transmission mode and a wireless power reception mode).

According to an embodiment, the external device 201 may include various types of devices that transmits power to the electronic device 101 in a wireless manner and supports a wireless charging function. For example, the electronic device 101 may correspond to various types of devices such as a smartphone, a tablet, a personal computer (PC), and/or a wireless charging pad. The electronic device 201 according to an embodiment of the disclosure is not limited to the above-described devices, and the electronic device 201 may correspond to various types of devices capable of transmitting wireless power. According to an embodiment, the external device 201 may operate as a power reception device that receives wireless power from another external device according to a wireless charging mode (e.g., a wireless power transmission mode and a wireless power reception mode).

According to an embodiment, the external device 201 may supply power to the electronic device 101 in a wireless manner, and the electronic device 101 may receive power from the external device 201 in a wireless manner.

According to an embodiment, the external device 201 may supply power to the electronic device 101 according to a standard scheme defined in the wireless charging wireless power consortium (WPC). According to an embodiment, the external device 201 and the electronic device 101 may include data in transferred power. According to an embodiment, the electronic device 101 and the external device 201 may mutually perform data transmission or reception (e.g., data communication) using a first communication channel 280 that uses a part of a frequency band corresponding to power transferred in a wireless manner. According to an embodiment, using the first communication channel 280, the electronic device 101 and the external device 201 may mutually perform transmission or reception of various types of data including charging-related information associated with wireless charging, identification information of the electronic device 101, identification information of the external device 201, and/or information indicating whether power transmitted in a wireless manner is received.

According to an embodiment, the first communication channel 280 may be a communication channel that uses a part of a frequency band that corresponds to power transferred in a wireless manner, and may be, for example, a communication channel used in an in-band communication scheme. The in-band communication scheme may transmit or receive data via a coil used for transmitting and receiving power in a wireless manner. For example, according to in-band communication, the electronic device 101 and the external device 201 may exchange a wireless power transmission signal and data via frequency modulation or amplitude modulation in the state of wireless power transmission performed between a coil of the electronic device 101 and a coil of the external device 201.

According to an embodiment, a bandwidth allocated to the first communication channel 280 may be narrower than a bandwidth allocated to another communication scheme. For example, the first communication channel 280 may have a data transmission speed of approximately 20 ~ 250 byte/sec, and in the case that data is transmitted or received using the first communication channel 280, data transmission or reception may not be smoothly performed due to a relatively slow data transmission speed. For example, the in-band communication may be vulnerable to noise caused by a change in an external voltage, and a probability that data communication will fail may be high in the case that alignment is misaligned. For example, a data transmission speed of data transmitted from the electronic device 101 to the external device 201 may be approximately 250 Byte/sec. As another example, a data transmission speed of data transmitted from the external device 201 to the electronic device 101 may be approximately 20 Byte/sec.

According to an embodiment, the electronic device 101 and the external device 201 may mutually perform data transmission and reception using a second communication channel 290 different from the first communication channel 280. According to an embodiment, the second communication channel 290 may be a communication channel used in an out-band (or out of band (OOB)) communication scheme that is a short-range wireless communication (e.g., Bluetooth, BLE, NFC, or Wi-Fi) scheme that performs data transmission or reception between the electronic device 101 and the external device 201. For example, out-band communication may be different from in-band communication that uses a wireless power signal, and may be short-range wireless communication such as Bluetooth, BLE, NFC, and/or Wi-Fi. According to an embodiment, a bandwidth allocated to the second communication channel 290 may be broader than a bandwidth allocated to the first communication channel 280. For example, the electronic device 101 and the external device 201 may mutually perform data transmission or reception using the second communication channel 290, and a probability of successful data transmission may be guaranteed when compared to data transmission using the first communication channel 280. For example, in the case of in-band communication, data is included in power and is transmitted via a coil, and thus a data transmission speed may be low. In the case that transferred power fluctuates (e.g., voltage fluctuation, voltage drop), data carried by the power also fluctuates, and thus a probability of failure of data transmission may be high. According to an embodiment, using the second communication channel 290, the electronic device 101 and the external device 201 may mutually perform transmission or reception of various types of data including charging-related information associated with wireless charging, identification information of the electronic device 101, identification information of the external device 201, and/or information related to charging efficiency when the electronic device 101 is charged.

According to an embodiment, FIG. 2 is a diagram illustrating an example of the configuration related to supporting wireless charging in the electronic device 101 and the external device 201 according to various embodiments. According to an embodiment, the electronic device 101 and the external device 201 illustrated in FIG. 2 may include at least part or the entirety of the component elements of the electronic device 101 as illustrated in the description provided with reference to FIG. 1. According to an embodiment, FIG. 2 illustrates an example in which the electronic device 101 is a wearable device (e.g., a watch) and the external device 201 is a smartphone or a charging pad. For example, although FIG. 2 illustrates that the electronic device 101 is a device capable of receiving wireless power, and the external device 201 is a device capable of transmitting wireless power, the electronic device 101 may be a device capable of transmitting wireless power or the external device 201 may be a device capable of receiving wireless power. Although the disclosure provides an example in which the electronic device 101 is a device (e.g., a reception device) that receives wireless power and the external device 201 is a device (e.g., a transmission device) that transmits (or supplies) wireless power, the electronic device 101 and the external device 201 may be configured to be identical or may be configured to provide any one of a wireless power transmission function or a wireless power reception function.

Referring to FIG. 2, the electronic device 101 according to an embodiment may include a wireless power reception circuit 210, a first battery 220 (e.g., the battery 189 of FIG. 1), a first communication module 230 (or communicator) comprising communication circuitry (e.g., the wireless communication module 192 of FIG. 1), a first memory 250 (e.g., the memory 130 of FIG. 1), an output module 240, and/or a first processor 260 (e.g., the processor 120 of FIG. 1).

According to an embodiment, the wireless power reception circuit 210 may receive power from the external device 201 in a wireless manner, and may charge the first battery 220. According to an embodiment, the wireless power reception circuit 210 may receive, from the external device 201, power using various schemes including a scheme defined in, for example, the wireless power consortium (WPC) standard, the Qi standard, and/or the power matters alliance (PMA) standard. According to an embodiment, the wireless power reception circuit 210 may perform wireless charging and data communication with the external device 201 via the first communication channel 280. According to an embodiment, the first communication channel 280 may be a channel for in-band communication. For example, the wireless power reception circuit 210 may control charging power input from the external device 201 via in-band communication, and may transmit charging-related data (or charging state information) corresponding to the input charging power to the external device 201 via in-band communication. According to an embodiment, in the case that out-band communication between the electronic device 101 and the external device 201 is connected, the electronic device 101 may transmit charging-related data to the external device 201 via the out-band communication. According to an embodiment, the charging-related data may include control data such as a control error packet (CEP), a received power packet (RPP), and/or an end of power transfer (EPT). According to an embodiment, some (e.g., a CEP and/or RPP) of the control data may be transmitted periodically to the external device 201 at designated intervals, respectively, and some other control data (e.g., an EPT) may be transmitted when a predetermined event occurs. According to an embodiment, although not illustrated in FIG. 2, the electronic device 101 may include a wireless power transmission circuit (not illustrated) that transmits power in a wireless manner, and may operate as a transmission device that supplies power to another electronic device (e.g., the external device 201).

According to an embodiment, the first battery 220 may supply power to at least one component element of the electronic device 101. According to an embodiment, the first battery 220 may be charged with power supplied from the wireless power reception circuit 210, the power being received from the external device 201. According to an embodiment, the first battery 220 may include, for example, a battery protection circuit (e.g., protection circuit module (PCM)). For example, the battery protection circuit may perform various functions (e.g., a previous breaking function) in order to prevent deterioration in performance or damage of the first battery 220. The battery protection circuit may be additionally or alternatively configured as at least a part of a battery management system (BMS) for performing cell balancing, measuring the capacity of a battery, measuring the number of times that charging/discharging is performed, measuring a temperature, or measuring a voltage.

According to an embodiment, the first communication module 230 may establish a wireless communication channel (e.g., the second communication channel 290) between the electronic device 101 and the external device 201, and may support communication performed via the established second communication channel 290. According to an embodiment, the first communication module 230 may support wireless communication of the electronic device 101 based on an out-band communication scheme (e.g., a short-range wireless communication scheme, for example, Bluetooth, BLE, NFC, and/or Wi-Fi). According to an embodiment, the electronic device 101 may perform, using the first communication module 230, communication with the external device 201 via the second communication channel 290 of an out-band communication scheme that is different from the first communication channel 280 of the in-band communication scheme. According to an embodiment, the first communication module 230 may perform data transmission or reception with the external device 201 via the second communication channel 290. According to an embodiment, the first communication module 230 may be in the state of being activated before operation (or initiation) of wireless charging with the external device 201, or may automatically switch into an activated state when operating wireless charging.

According to an embodiment, the output module 240 may include at least one from among a display module (e.g., the display module 160 of FIG. 1) that may visually provide information to the outside of the electronic device 101 (e.g., a user), a sound output module (e.g., the sound output module 155 of FIG. 1) (e.g., a speaker) that may output a sound signal to the outside of the electronic device 101, and a haptic module (e.g., the haptic module 179 of FIG. 1) that may convert an electric signal into a mechanical stimulus (e.g., a vibration or movement) or an electrical stimulus that a user is capable of recognizing via a sense of tactile or a sense of movement, and may output the same. According to an embodiment, the output module 240 may visibly, audibly, and/or tactually (e.g., vibrationally) output various types of state information related to charging of the electronic device 101 (e.g., charging guide (or state) information, notification information associated with misalignment).

According to an embodiment, the first memory 250 may correspond to the memory 130 as described with reference to FIG. 1. According to an embodiment, the first memory 250 may store various types of data used by the electronic device 101 when wireless charging is performed. According to an embodiment, data may include various types of data used by the electronic device 101 when wireless charging is performed, such an identification ((ID) packet) including a WPC version and/or a manufacturer unique code of the electronic device 101, a power class, a configuration packet including power required by the electronic device 101, identification information (or device information) (e.g., ID) of the electronic device 101, and/or control data such as a control error packet (CEP), a received power packet (RPP), and/or an end of power transfer (EPT). According to an embodiment, data may include, for example, input data or output data associated with software (e.g., the program 140) and a related command. According to an embodiment, the first memory 250 may store instructions to enable the first processor 260 to operate when the instructions are executed.

According to an embodiment, the first processor 260 may control wireless charging using the first communication channel 280 of the in-band communication scheme performed with the external device 201. According to an embodiment, the first processor 260 may obtain information (or data) associated with charging efficiency calculated by the external device 201 from the external device 201 via the second communication channel 290 of the out-band communication scheme when wireless charging is performed. According to an embodiment, the first processor 260 may identity misalignment based on the obtained information, and may provide notification information based on a result of the identification. According to an embodiment, the first processor 260 may control an operation related to wireless charging of the electronic device 101 (e.g., wireless charging according to a reception mode). According to an embodiment of the disclosure, a wireless charging control operation of the first processor 260 will be described in detail with reference to drawings.

According to an embodiment, operations performed by the first processor 260 may be embodied as software (e.g., the program 140 of FIG. 1) including one or more instructions stored in a storage medium (e.g., the first memory 250) readable by the first processor 260. For example, operations performed by the first processor 260 may be stored in the first memory 250, and may be executed by instructions that enable the processor 260 to perform operations when the instructions are executed.

Referring to FIG. 2, the external device 201 according to an embodiment may include a wireless power transmission circuit 215, a power management module 245, a second battery 225, a second communication module 235 (or communicator) comprising communication circuitry, a second memory 255, and/or a second processor 265.

According to an embodiment, the wireless power transmission circuit 215 may transmit power to the electronic device 101 in a wireless manner. According to an embodiment, the wireless power transmission circuit 215 of the electronic device 201 may be connected to an external power device (an external power source) (or a wired power supply device) (e.g., a travel adapter, TA) and may provide power to the electronic device 101 via the wireless power transmission circuit 215 by using power supplied from the external power device or power of the second battery 225 of the external device 201. According to an embodiment, the wireless power transmission circuit 215 may transmit wireless power (e.g., charging power) to the electronic device 101. According to an embodiment, charging power may be transmitted via in-band communication between the wireless power transmission circuit 215 and the electronic device 101 (e.g., the wireless power reception circuit 210). According to an embodiment, although not illustrated in FIG. 2, the external device 201 may include a wireless power reception circuit (not illustrated) that receives power in a wireless manner, and may operate as a reception device that receives power from another electronic device (e.g., the electronic device 101).

According to an embodiment, a power management module 245 may manage power supplied to the external device 201. According to an embodiment, the power management module 245, for example, may be implemented as at least a part of a power management integrated circuit (PMIC). According to an embodiment, the power management module 245 may charge the second battery 225 using power supplied from an external power source. According to an embodiment, when a wireless power transmission mode (e.g., a wireless battery sharing mode) of the external device 201 operates, the power management module 245 may transfer power supplied from an external power source or the second battery 225 to the wireless power transmission circuit 215 so that power is shared with the electronic device 101 via the wireless power transmission circuit 215.

According to an embodiment, the second battery 225 may supply power to at least one component element of the electronic device 201. According to an embodiment, the second battery 225 may be charged with power supplied from the power management module 245, the power being received from an external power source. According to an embodiment, the second battery 225 may include a battery protection circuit (PCM). For example, the battery protection circuit may perform various functions (e.g., a previous breaking function) in order to prevent deterioration in performance or damage of the second battery 225. The battery protection circuit may be additionally or alternatively configured as at least a part of a battery management system (BMS) for performing cell balancing, measuring the capacity of a battery, measuring the number of times that charging/discharging is performed, measuring a temperature, or measuring a voltage.

According to an embodiment, the second communication module 235 may establish a wireless communication channel (e.g., the second communication channel 290) between the external device 201 and the electronic device 101 and may support communication performed via the established second communication channel 290. According to an embodiment, the second communication module 235 may support wireless communication of the external device 201 based on an out-band communication scheme (e.g., a short-range wireless communication scheme, for example, Bluetooth, BLE, NFC, and/or Wi-Fi). According to an embodiment, the external device 201 may perform, using the second communication module 235, communication with the electronic device 101 via the second communication channel 290 (e.g., a short-range communication network) of an out-band communication scheme that is different from the first communication channel 280 of the in-band communication scheme. According to an embodiment, the second communication module 235 may perform data transmission or reception with the electronic device 101 via the second communication channel 290. According to an embodiment, the second communication module 235 may be in the state of being activated before operation (or initiation) of wireless charging with the electronic device 101, or may automatically switch into an activated state when operating wireless charging.

According to an embodiment, the second memory 255 may correspond to the memory 130 as described with reference to FIG. 1. According to an embodiment, the second memory 255 may store various types of data used by the external device 201 when wireless charging is performed. According to an embodiment, data may include various types of data used by the external device 201 when wireless charging is performed, such as an identification packet including a WPC version and/or a manufacturer unique code of the external device 201, a power class, a configuration packet including power required by the electronic device 101, and/or control data (e.g., a CEP, an RPP, and/or an EPT) received from the electronic device 201. According to an embodiment, data may include information associated with charging efficiency related to the electronic device 101 that is calculated based on the information obtained from the electronic device 101. According to an embodiment, data may include, for example, input data or output data associated with software (e.g., the program 140) and a related command. According to an embodiment, the second memory 255 may store instructions to enable the second processor 265 to operate when the instructions are executed.

According to an embodiment, the second processor 265 may control wireless charging using the first communication channel 280 according to the in-band communication scheme performed with the electronic device 101, and may calculate charging efficiency of the electronic device 201 when wireless charging is performed. According to an embodiment, the second processor 265 may calculate charging efficiency of the electronic device 101 based on information obtained from the electronic device 101 via the in-band communication. According to an embodiment, the second processor 265 may transmit information (or data) associated with the calculated charging efficiency to the electronic device 101 using the second communication channel 290 of the out-band communication scheme. According to an embodiment, the second processor 265 may detect trigger for converting a power transfer state to a power transfer suspension state, and may disconnect the first communication channel 280 and/or the second communication channel 290. For example, the second processor 265 may identify whether data (e.g., a CEP) designated by the electronic device 101 is received via the first communication channel 280 while wireless charging is performed, may determine suspending power transferring when the designated data is not received, may suspend wireless power transferring by the first communication channel 280 (or may terminate (deactivate) a transmission mode (e.g., a wireless battery sharing mode)), and/or may control the second communication module 235 to disconnect the second communication channel 290. According to an embodiment, in the state in which information associated with charging efficiency of the electronic device 101 is transmitted via the second communication channel 290, the second processor 265 may not immediately suspend a transmission mode although the designated data (e.g., a CEP) is not received, but may maintain the transmission mode or may suspend the transmission mode after standing by a predetermined period of time. Through the above operation, a user may stand by a period of time spent in adjusting alignment of the electronic device 101 and the external device 201, and thus the user may avoid inconvenience caused by reoperation for wireless charging (e.g., an operation such as connection and transmission mode activation of the external device 201).

According to an embodiment, the second processor 265 may control an operation related to wireless charging of the electronic device 201 (e.g., wireless charging according to a transmission mode). According to an embodiment, a wireless charging control operation of the second processor 265 will be described in detail with reference to drawings. According to an embodiment, operations performed by the second processor 265 may be embodied as software (e.g., the program 140 of FIG. 1) including one or more instructions stored in a storage medium (e.g., the second memory 255) readable by the second processor 265. For example, operations performed by the second processor 265 may be stored in the second memory 255, and may be executed by instructions that enable the second processor 265 to perform operations when the instructions are executed.

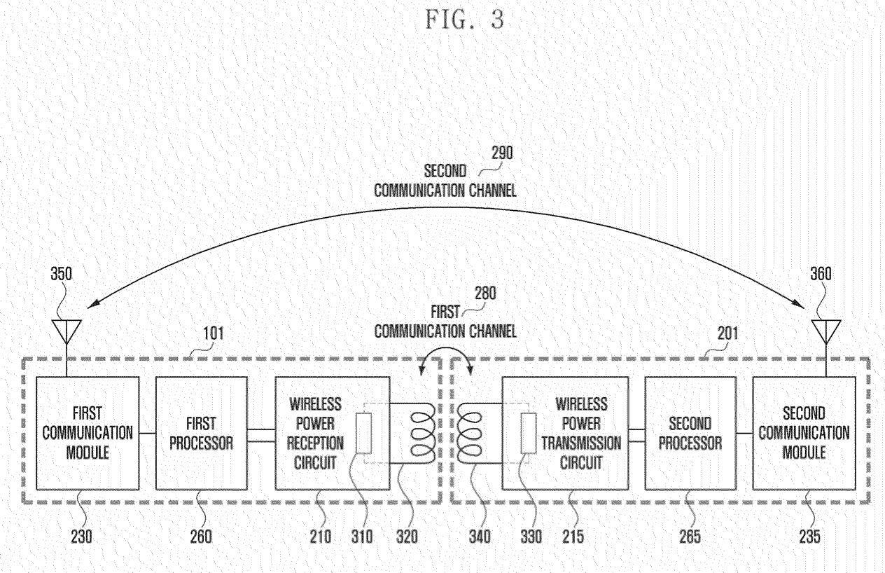

FIG. 3 is a diagram illustrating a first communication channel and a second communication channel used between an electronic device and an external device according to various embodiments.

FIG. 3 illustrates some component elements of the electronic device 101 (e.g., the electronic device 101 of FIG. 2) and the external device 201 (e.g., the external device 201 of FIG. 2).

Referring to FIG. 3, the electronic device 101 may include the wireless power reception circuit 210, the first communication module 230 (or communicator) comprising communication circuitry, and the first processor 260.

According to an embodiment, the wireless power reception circuit 210 may receive wireless power transmitted by the external device 201. According to an embodiment, a scheme of receiving power in a wireless manner may include various schemes including a magnetic induction scheme (e.g., a Qi scheme or a PMA scheme) and a resonant induction scheme, and the wireless power reception circuit 210 may receive power from the external device 201 using various schemes.

According to an embodiment, the wireless power reception circuit 210 may transmit data to the external device 201 using the first communication channel 280 that uses a part of the frequency band used for transmitting power. The wireless power reception circuit 210 may include a communication circuit 310 that controls a series of operations including connecting or disconnecting the first communication channel 280 via in-band communication which uses a coil 320.

According to an embodiment, the first communication module 230 may establish the second communication channel 290 via a short-range wireless communication scheme (e.g., Wi-Fi, Bluetooth, BLE, and/or NFC) (e.g., out-band communication) and may communicate with the external device 201 via the second communication channel 290. According to an embodiment, the first communication module 230 may include an antenna 350 (e.g., or an antenna pattern) in order to use out-band communication, and may perform data transmission or reception with the external device 201 via the antenna 350.

According to an embodiment, the first processor 260 may control operation of the wireless power reception circuit 210 and the first communication module 230. According to an embodiment, based on a wireless charging operation performed with the external device 201, the first processor 260 may transmit information (e.g., a CEP, an RPP, and/or an EPT) corresponding to a request for power via the first communication channel 280 according to in-band communication. According to an embodiment, in the case that out-band communication is connected between the electronic device 101 and the external device 201, the first processor 260 may transmit information corresponding to a request for power via the second communication channel 290 according to out-band communication. According to an embodiment, while performing wireless charging, the first processor 260 may control the first communication module 230 to receive information related to charging efficiency from the external device 201 via the second communication channel 290 according to out-band communication. According to an embodiment, the first processor 260 may identify charging efficiency of the electronic device 101 based on information related to charging efficiency, and may provide, based on a result of the identification, guide information related to charging or notification information related to misalignment.

Referring to FIG. 2, the external device 201 may include the wireless power transmission circuit 215, the second communication module 235 (or communicator) comprising communication circuitry, and the second processor 265.

According to an embodiment, the wireless power transmission circuit 215 may transmit power to the electronic device 101 in a wireless manner. According to an embodiment, a scheme of transmitting power in a wireless manner may include various schemes including, for example, a magnetic induction scheme (e.g., a Qi scheme or a PMA scheme) and a resonant induction scheme, and the wireless power transmission circuit 215 may transmit power from the electronic device 101 using various schemes. According to an embodiment, the wireless power transmission circuit 215 may receive data (e.g., a CEP, an RPP, and/or an EPT) from an electronic device 101 via the first communication channel 280 that uses a part of the frequency band used for transmitting power. The wireless power transmission circuit 215 may include a communication circuit 330 that controls a series of operations including connecting or disconnecting the first communication channel 280 via in-band communication that uses the coil 340.

According to an embodiment, the second communication module 235 may establish the second communication channel 290 via a short-range wireless communication scheme (e.g., Wi-Fi, Bluetooth, BLE, and/or NFC) (e.g., out-band communication), and may communicate with the electronic device 101 via the second communication channel 290. According to an embodiment, the second communication module 235 may include an antenna 360 (e.g., or an antenna pattern) in order to use out-band communication, and may perform data transmission or reception with the electronic device 101 via the antenna 360.

According to an embodiment, the second processor 265 may control operation of the wireless power transmission circuit 215 and the second communication module 235. According to an embodiment, the second processor 265 may receive information (e.g., a CEP, an RPP, and/or an EPT) corresponding to a request of the electronic device 101 for power via the first communication channel 280 according to in-band communication. According to an embodiment, in the case that out-band communication is connected between the electronic device 101 and the external device 201, the second processor 265 may receive information corresponding to a request of the electronic device 101 for power via the second communication channel 290 according to out-band communication. According to an embodiment, the second processor 265 may control the second communication module 235 to transmit information related to charging efficiency of the external device 201 calculated based on the received information, via the second communication channel 290 according to out-band communication.

The electronic device 101 according to various embodiments of the disclosure may include a wireless power reception circuit (e.g., the wireless power reception circuit 210 of FIG. 2 or FIG. 3), the communication module 230 (e.g., the first communication module 230 of FIG. 2 or FIG. 3), and a processor (e.g., the processor 120 of FIG. 1 or the first processor 260 of FIG. 2 or FIG. 3) operatively connected to the wireless power reception circuit and the communication module, and the processor may be configured to control, based on initiation of wireless charging, power input from an external device via the wireless power reception circuit, to transmit first information produced based on the input power to the external device via designated communication, to receive, from the external device via out-band communication using the communication module, second information that is related to a charging efficiency of the electronic device calculated by the external device, and to provide, based on the second information, a location change notification for the electronic device.

According to various embodiments of the disclosure, the processor may be configured to produce, based on the power input from the external device, the first information related to charging, and to transmit the first information to the external device via in-band communication or the out-band communication, and the first information may include control data corresponding to a received power packet (RPP) and/or a control error packet (CEP).

According to various embodiments of the disclosure, the processor may be configured to activate, based on a state of the communication module, the communication module when initiating the wireless charging or transmitting the first information, and to establish, via the communication module, a communication channel for the out-band communication with the external device.

According to various embodiments of the disclosure, the second information may include charging efficiency of the electronic device that is calculated by the external device based on reception power of the electronic device and transmission power of the external device.

According to various embodiments of the disclosure, the second information may be calculated, by the external device, based on a power ratio of reception power of the electronic device identified from the first information to transmission power transmitted from the external device.

According to various embodiments of the disclosure, the processor may be configured to compare a first charging efficiency based on the second information and a second charging efficiency set for the electronic device, and to determine, based on a difference between the first charging efficiency and the second charging efficiency, whether alignment or misalignment occurs.

According to various embodiments of the disclosure, the processor may be configured to provide, based on the determination indicating that alignment occurs, a first guide related to wireless charging, and to provide, based on the determination indicating that misalignment occurs, a second guide related to location alignment.

According to various embodiments of the disclosure, the processor may be configured to provide a notification associated with misalignment for each level based on the degree of the difference between the first charging efficiency and the second charging efficiency.

According to various embodiments of the disclosure, the processor may be configured to determine, based on a difference between the first charging efficiency and the second charging efficiency, whether the first charging efficiency falls within a normal range, to determine that alignment occurs in a case that the first charging efficiency falls within the normal range and to provide a notification related to wireless charging via an output module of the electronic device, and to determine that misalignment occurs in a case that the first charging efficiency is beyond the normal range and to provide a location change notification via the output module.

According to various embodiments of the disclosure, the in-band communication may include communication that uses a wireless power signal between a coil of the electronic device and a coil of the external device, and the out-band communication may include short-range wireless communication different from the in-band communication.

Hereinafter, an operation method of the electronic device 101 and the external device 201 according to various embodiments will be described in detail. According to various embodiments, operations performed by the electronic device 101 described below may be executed by a processor (e.g., the first processor 260 of FIG. 2) including at least one processing circuit of the electronic device 101. According to an embodiment, the operations performed by the electronic device 101 may be stored in a memory (e.g., the first memory 250 of FIG. 2) and may be executed by instructions configured to enable a processor (e.g., the first processor 260 of FIG. 2) to perform operation when the instructions are executed. According to various embodiments, operations performed by the external device 201 described below may be executed by a processor (e.g., the second processor 265 of FIG. 2) including at least one processing circuit of the external device 201. According to an embodiment, the operations performed by the electronic device 201 may be stored in a memory (e.g., the second memory 255 of FIG. 2) and may be executed by instructions configured to enable a processor (e.g., the second processor 265 of FIG. 2) to perform operation when the instructions are executed.

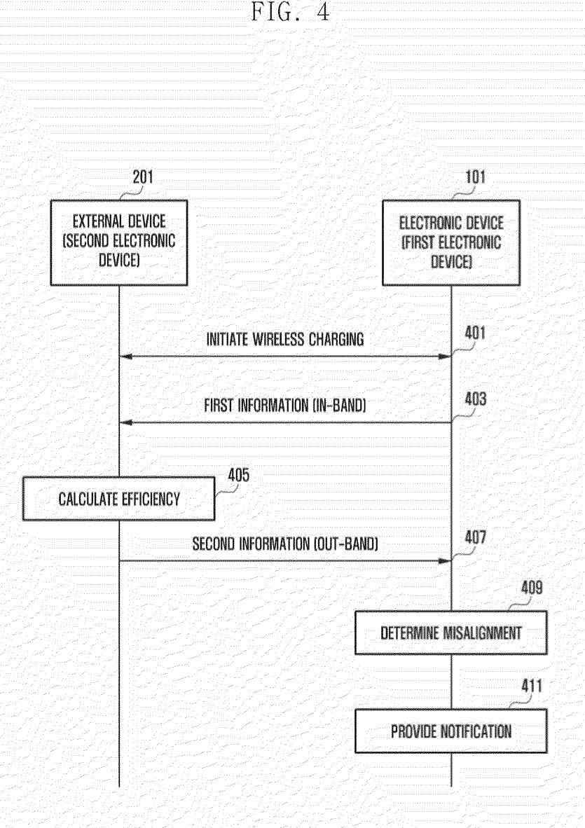

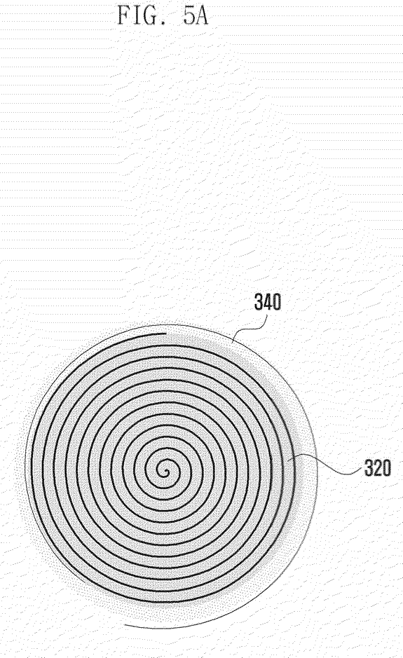

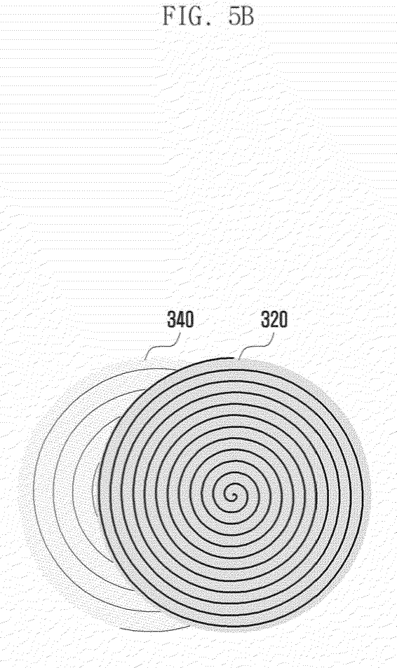

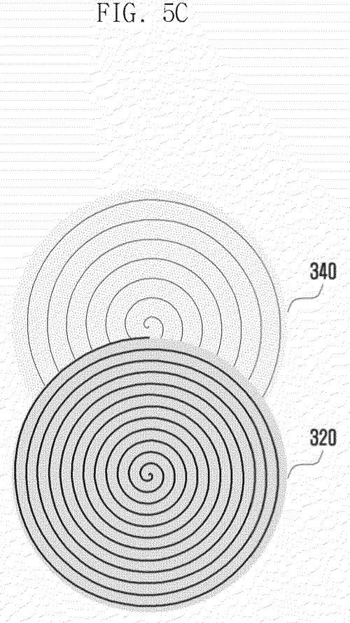

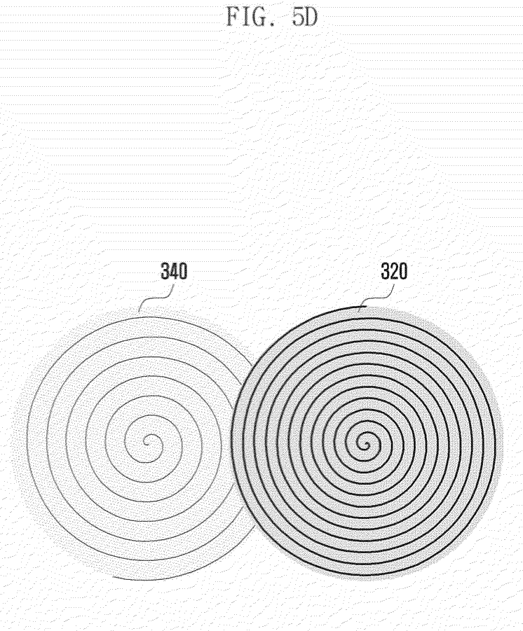

FIG. 4 is a diagram illustrating an operation of performing communication between an electronic device and an external device according to various embodiments. FIGS. 5A, 5B, 5C, and 5D are diagrams illustrating charging efficiency based on the degree of alignment between an electronic device and an external device according to an embodiment.

Referring to FIG. 4, in operation 401, the electronic device 101 (or a first electronic device) and the external device 201 (or a second electronic device) may initiate wireless charging. According to an embodiment, a user may operate the external device 201 so as to activate a transmission mode (e.g., a wireless battery sharing mode) for sharing a wireless battery, or the external device 201 may automatically activate a transmission mode based on detection of the electronic device 101 being in contact. According to an embodiment, the user may dispose the external device 201 and the electronic device 101 so that a direction in which the coil (e.g., the coil 320 of FIG. 3) of the electronic device 101 is disposed faces a direction (a backside (or rear) direction of the external device 201) in which the coil (e.g., the coil 340 of FIG. 3) of the external device 201 is disposed (e.g., bringing them in close contact such as placing the electronic device 101 on the external device 201). According to an embodiment, the electronic device 101 and the external device 201 may initiate wireless charging based on user operation. For example, the external device 201 may transmit (or share) wireless power via the coil 340 and the electronic device 101 may receive wireless power via the coil 320 and may charge a battery (e.g., the first battery 220 of FIG. 2).

In operation 403, based on initiation of wireless charging, the electronic device 101 may transmit first information (e.g., control data) (e.g., a CEP, an RPP, and/or an EPT) related to charging to the external device 201. According to an embodiment, the electronic device 101 may transmit first information (e.g., an RPP, a CEP) that requests power from the external device 201 to the external device 201 via in-band communication (e.g., the first communication channel 280 of FIG. 2 or FIG. 3). According to an embodiment, in the case that out-band communication is connected between the electronic device 101 and the external device 201, the electronic device 101 may transmit first information that requests power from the external device 201 to the external device 201 via out-band communication (e.g., the second communication channel 290 of FIG. 2 or FIG. 3). According to an embodiment, according to a wireless charging standard (e.g., the WPC standard), the electronic device 101 (e.g., a reception device) that receives wireless charging power may transmit (e.g., share), via an RPP at designated intervals (e.g., at intervals of approximately 1.5 seconds), information associated with power that the electronic device 101 receives from the external device 201 to the external device 201 (e.g., a transmission device) that provides (or supplies) wireless charging power. According to an embodiment, the RPP may calculated based on an average value of a reference voltage (e.g., a rectified voltage (VRECT)) and an output current (IOUT) sample. Here, the electronic device 101 may not be aware of the magnitude of power that the external device 201 actually transfers, and may request, via a CEP, the external device 201 to transmit power higher or lower than the power currently received. According to an embodiment, the CEP may include a value calculated based on a difference (or an offset) between a reference voltage (e.g., a rectified voltage) designated for wireless charging for the electronic device 101 and a reception voltage received from the external device 201. For example, the CEP may be a packet transmitted to the external device 201 that transmits charging power, and indicating whether the electronic device 101 needs to receive a larger amount of power or a smaller amount of power than the currently received power. According to an embodiment, the electronic device 101 may compare the amount of power requested and the amount of power received in advance, and may transmit a CEP at first designated intervals (e.g., at intervals of approximately 50 ms) when a difference from the power received in advance is greater than or equal to a designated reference (or when the difference is significantly high) and may transmit a CEP at second designated intervals (e.g., at intervals of approximately 150 ms) when the difference is less than the designated reference (or when the difference is low).

According to an embodiment, the electronic device 101 may provide first information to the external device 201 via in-band communication (e.g., the first communication channel 280 of FIG. 2 or FIG. 3). According to an embodiment, the in-band communication may exchange data between the electronic device 101 and the external device 201 via a wireless power transmission signal and frequency modulation or amplitude modulation in the state of wireless power transmission between the coil 320 of the electronic device 101 and the coil 340 of the external device 201.

In operation 405, the external device 201 may calculate charging efficiency of the electronic device 101. According to an embodiment, charging efficiency between the electronic device 101 and the external device 201 will be described with reference to FIGS. 5A, 5B, 5C, and 5D.

According to an embodiment, the electronic device 101 may be unaware of the magnitude of power that the external device 201 currently transmits, and may continuously transmit first information by comparing power received from the external device 201 and charging power of the electronic device 101 as shown in operation 403. For example, if it is assumed that the charging efficiency of the electronic device 101 is approximately 80%, power that the electronic device 101 receives may be approximately 80 when the external device 201 transmits power of approximately 100 and power of approximately 20 may be lost in the form of heat or the like.

According to an embodiment, as illustrated in FIG. 5A, if it is assumed that a location in which the coil 320 of the electronic device 101 and the coil 340 of the external device 201 are in contact (or close to each other) is an optimal location, the external device 201 may transmit power of approximately 100 and the electronic device 101 may receive power of approximate 80.

According to an embodiment, as illustrated in FIGS. 5B or 5C, if the location in which the coil 320 of the electronic device 101 and the coil 340 of the external device 201 are in contact (or close to each other) is not an optimal location, the electronic device 101 may request higher power from the external device 201 by transmitting designated information (e.g., a CEP packet) in order to receive power of approximately 80, and the external device 201 that receives the information may raise charging power and may transmit power of approximately 120, instead of power of approximately 100. Therefore, the electronic device 101 may receive power of approximately 80 that the electronic device 101 desires. However, the electronic device 101 may not be aware whether the external device 201 transmits power of approximately 120, and in this instance, the substantial charging efficiency may be decreased to approximately 66.6% from the existing charging efficiency of approximately 80%.

According to an embodiment, as illustrated in FIG. 5D, in the case that the location of the coil 320 of the electronic device 101 and the location of the coil 340 of the external device 201 are far more misaligned, the electronic device 101 may merely receive, for example, power of approximately 50 when the external device 201 transmits power of approximately 200. In this instance, the substantial charging efficiency may be decreased to approximately 25%.

According to an embodiment, in the case that the charging efficiency is decreased, the power, excluding the power that the electronic device 101 receives from the power that the external device 201 transmits, may be a factor of generation of heat. Therefore, in the case that heat is generated from the electronic device 101 while wireless charging is performed between the electronic device 101 and the external device 201, charging may be controlled to protect a battery, such as reducing a charging current or the like. Accordingly, a charging speed may be relatively slower than when charging efficiency is high and a charging time may be longer than when charging efficiency is high.

According to an embodiment of the disclosure, the external device 201 may be aware of power (e.g., the magnitude of power) transmitted by the external device 201 and, based on the first information (e.g., a CEP and/or an RPP) obtained from the electronic device 101 via in-band communication, may also be aware of power that the electronic device 101 receives. Therefore, according to an embodiment of the disclosure, based on transmission power transmitted by the external device 201 and reception power of the electronic device 101 identified based on the first information, the external device 201 may calculate the substantial charging efficiency of the electronic device 101 as shown in Equation 1 below. For example, the external device 201 may calculate charging efficiency using a power ratio between reception power and transmission power.

$$\text{charging} \text{efficiency} = \frac{r e c e p t i o n p o w e r}{t r a n s m i s s i o n p o w e r} \times 100 \% \qquad \text{Equation 1:}$$

According to an embodiment, it is assumed that charging efficiency set for the electronic device 101 is approximately 80% (e.g., optimal charging efficiency for the electronic device 101 may be differently set depending on the design of hardware) and the external device 201 transmits transmission power of approximately 100 and the electronic device 101 receives reception power of approximately 80, the charging efficiency may be calculated to be approximately 80%. For example, the calculated charging efficiency of approximately 80% and the charging efficiency of approximately 80 % set for the electronic device 101 may be identical, and the location in which the coil 320 of the electronic device 101 and the coil 340 of the external device 201 are in contact may be in an optimal state. According to another embodiment, if it is assumed that the external device 201 transmits transmission power of approximately 100 and the electronic device 101 receives reception power of approximately 60, charging efficiency may be calculated to be approximately 60%. For example, the calculated charging efficiency of approximately 60% and the charging efficiency of approximately 80 % set for the electronic device 101 may be different, and the location in which the coil 320 of the electronic device 101 and the coil 340 of the external device 201 are in contact may be in a misaligned state (e.g., misalignment). According to another embodiment, if it is assumed that the external device 201 transmits transmission power of approximately 150 and the electronic device 101 receives reception power of approximately 50, charging efficiency may be calculated to be approximately 33%. For example, the calculated charging efficiency of approximately 33% and the charging efficiency of approximately 80% set for the electronic device 101 may be different, and the location in which the coil 320 of the electronic device 101 and the coil 340 of the external device 201 are in contact may be far more misaligned.

In operation 407, the external device 201 may transmit second information related to calculated charging efficiency (e.g., substantial charging efficiency in consideration of the electronic device 101 and the external device 201) to the electronic device 101. According to an embodiment, the external device 201 may transmit the second information related to charging efficiency of the electronic device 101 to the electronic device 101 via out-band communication (e.g., the second communication channel 290 of FIG. 2 or FIG. 3).

In operation 409, the electronic device 101 may determine whether misalignment occurs. According to an embodiment, the electronic device 101 may receive the second information (e.g., charging efficiency calculated by the external device 201) from the external device 201 via out-band communication while wireless charging is performed via in-band communication. According to an embodiment, the electronic device 101 may compare the received second information (e.g., calculated charging efficiency) and the charging efficiency (e.g., a reference charging efficiency) set for the electronic device 101, and may determine, based on a result of the comparison, whether misalignment occurs. According to an embodiment, based on a difference between the calculated charging efficiency and the reference charging efficiency, the electronic device 101 may determine whether alignment or misalignment occurs. For example, in the case that the calculated charging efficiency is approximately 80% and the reference charging efficiency is approximately 80%, the electronic device 101 may determine that it is an optimal alignment state. As another example, in the case that the calculated charging efficiency is approximately 60% and the reference charging efficiency is approximately 80%, the electronic device 101 may determine that it is a misalignment state. According to an embodiment, based on the degree of the difference between the calculated charging efficiency and the reference charging efficiency, the electronic device 101 may distinguish misalignment in different levels.

In operation 411, the electronic device 101 may provide a notification based on a result of the determination. According to an embodiment, based on determination indicating that alignment occurs, the electronic device 101 may provide a guide notification related to wireless charging (e.g., information associated with a charging state or level) via an output module (e.g., the output module 240 of FIG. 2). According to another embodiment, based on determination indicating that misalignment occurs, the electronic device 101 may provide an alignment notification related to location alignment (e.g., information related to a misalignment state or warning) via an output module (e.g., the output module 240 of FIG. 2).

According to an embodiment of the disclosure, based on the alignment notification related to location alignment, a user may change the location of the electronic device 101 placed on the external device 201, and may easily find out a location that provides optimal charging efficiency. According to an embodiment, the electronic device 101 may periodically transmit first information to the external device 201 via in-band communication and/or out-band communication. According to an embodiment, reception power changed via location adjustment by a user may be transferred to the external device 201, and charging efficiency may be recalculated and transferred to the electronic device 101. According to an embodiment, based on the recalculated charging efficiency, the electronic device 101 may redetermine whether misalignment occurs. According to an embodiment of the disclosure, based on such operations performed, an alignment notification provided for each level associated with changed charging efficiency may provide guidance so that a user easily finds out a location that provides optimal charging efficiency.

According to an embodiment, conventionally, the electronic device 101 (e.g., a reception device) that receives power may operate to receive desired power without taking into consideration efficiency of the external device 201 (e.g., a transmission device) that transmits power. Therefore, conventionally, irrespective of a decrease in charging efficiency caused by misalignment of the electronic device 101, the external device 201 may transmit high power in order to supply the power desired by the electronic device 101, and thus battery consumption by the external device 201 may be high. According to various embodiments of the disclosure, by calculating substantial charging efficiency in consideration of the efficiency of the electronic device 101 and the efficiency of the external device 201, a guide associated with misalignment may be provided in the electronic device 101, and optimal charging efficiency may be provided to the electronic device 101 while battery consumption by the external device 201 is reduced. According to various embodiments, an accurate (detailed) positioning guide may be provided to a user by providing a guide to the user for each level of misalignment. According to various embodiments, a charging-enabled area may be divided narrowly, a charging speed may be improved since heat is less generated than before if charging is performed at a location that shows peak efficiency, and battery consumption of the external device 201 may be reduced since charging efficiency is improved.

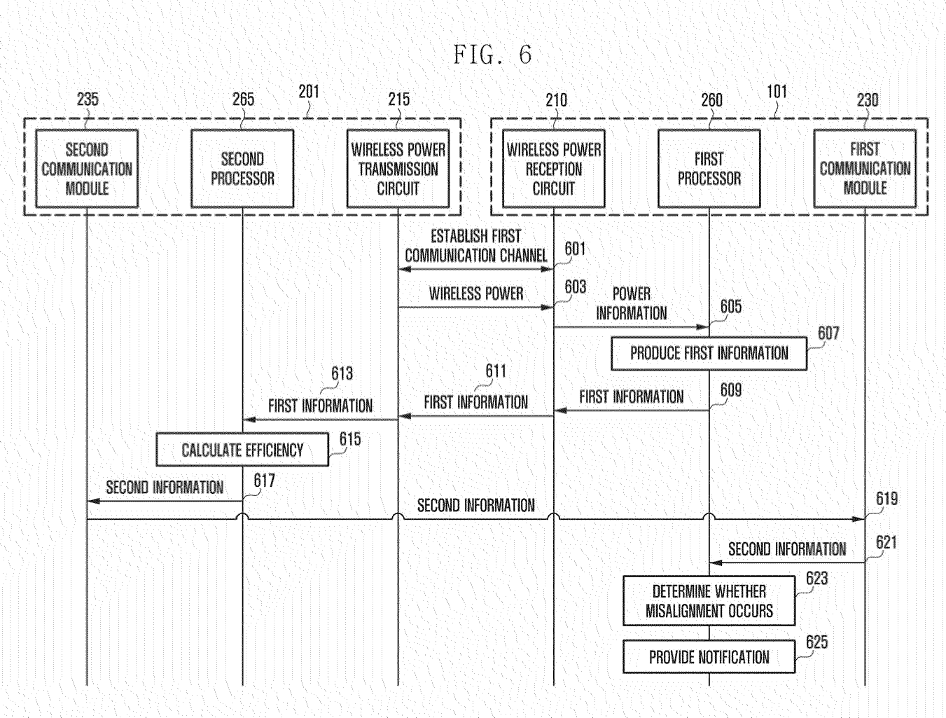

FIG. 6 is a diagram illustrating an operation of performing communication between an electronic device and an external device according to various embodiments.

Referring to FIG. 6, in operation 601, a first communication channel (e.g., the first communication channel 280 of FIG. 2 or FIG. 3) may be established between the wireless power transmission circuit 215 of the external device 201 and the wireless power reception circuit 210 of the electronic device 101. According to an embodiment, the wireless power transmission circuit 215 of the external device 201 may broadcast a ping signal, and the wireless power reception circuit 210 of the electronic device 101 that receives a broadcasted ping signal may transmit a response signal. According to an embodiment, based on whether a response signal is received, the wireless power transmission circuit 215 may detect whether the electronic device 101 is close thereto.

In operation 603, the wireless power transmission circuit 215 may transmit (or share) wireless power to the wireless power reception circuit 210 via the first communication channel.

According to an embodiment, the wireless power transmission circuit 215 and the wireless power reception circuit 210 may establish the first communication channel and transmit power by sequentially switching phases including a ping detection phase for detecting whether the external device 201 and the electronic device 101 are close to each other, a configuration phase for establishing a connection for wireless power transmission between the external device 201 and the electronic device 101, and/or a power transfer phase for transmitting power from the external device 201 to the electronic device 101.

In operation 605, the wireless power reception circuit 210 may transfer power information related to power received from the wireless power transmission circuit 215 (e.g., a voltage, a current, and/or power input) to the first processor 260 of the electronic device 101.

According to an embodiment, the wireless power reception circuit 210 may include a control logic (e.g., a sub-processor or RX IC) and a charging circuit (charger IC). According to an embodiment, the wireless power reception circuit 210 may measure power input (e.g., a voltage, a current, and/or power input) by the wireless power transmission circuit 215 by using a control logic, and may charge a battery (e.g., the first battery 220 of FIG. 2) with the power measured by the control logic by using a charging circuit. According to an embodiment, the wireless power reception circuit 210 may control (or measure), using a control logic, power input from the wireless power transmission circuit 215, so as to produce first information (e.g., a CEP, an RPP), and may directly transmit the produced first information to the external device 201 according to in-band communication (e.g., operation 611) or may provide the first information to the first processor 260 so as to transmit the same to the external device 201 according to out-band communication. According to an embodiment, in the case that the wireless power reception circuit 210 controls an operation related to the first information, operations 605, 607, and 609 of the first processor 260 may not be performed and omitted.

In operation 607, the first processor 260 may produce first information (e.g., a CEP, an RPP). According to an embodiment, the first processor 260 may measure power input (e.g., a voltage, a current, and/or power input) via the wireless power transmission circuit 215 of the external device 201, and may produce the first information based on the measurement. According to an embodiment, the first processor 260 may calculate an average value of a reference voltage (e.g., a rectified voltage (VRECT)) and an output current (IOUT) sample, and may calculate an RPP based on the average value. According to an embodiment, based on information associated with received power compared to charging efficiency set for the electronic device 101, the first processor 260 may produce a CEP that requests the external device 201 to transmit power higher or lower than the currently received power. According to an embodiment, the first processor 260 may calculate the CEP based on a difference (e.g., an offset) between a reference voltage (e.g., a rectified voltage) designated for wireless charging of the electronic device 101 and a reception voltage received from the external device 201. For example, the CEP may be a packet transmitted to the external device 201 that transmits charging power, and indicating whether the electronic device 101 needs to receive a larger amount of power or a smaller amount of power than the current power while charging is performed.

In operation 609, the first processor 260 may transfer the first information to the wireless power reception circuit 210.

In operation 611, the wireless power reception circuit 210 may transmit the first information to the wireless power transmission circuit 215 of the external device 201 according to in-band communication by using the first communication channel.

In operation 613, the wireless power transmission circuit 215 may transfer the first information received from the wireless power reception circuit 210 to the second processor 265.

In operation 615, the second processor 265 may calculate charging efficiency associated with the electronic device 101. According to an embodiment, using the transmission power (e.g., the magnitude of power) that the external device 201 transmits via the wireless power transmission circuit 215 and first information (e.g., a CEP and/or an RPP) obtained from the electronic device 101 according to in-band communication, the second processor 265 may calculate charging efficiency of the electronic device 101. For example, based on the transmission power of the external device 201 and the reception power of the electronic device 101, the second processor 265 may calculate substantial charging efficiency in consideration of the external device 201 and the electronic device 101 as given in Equation 1.

In operation 617, the second processor 265 may produce second information related to the calculated charging efficiency (substantial charging efficiency in consideration of the electronic device 101 and the external device 201), and may transfer the second information to the second communication module 235 (or communicator) comprising communication circuitry. According to an embodiment, the second processor 265 may activate the second communication module 235, and may further perform a series of operations (e.g., pairing or connecting a session) for connecting the first communication module 230 (or communicator) comprising communication circuitry and a second communication channel.

In operation 619, using the second communication channel (e.g., the second communication channel 290 of FIG. 2 or FIG. 3), the second communication module 235 may transmit the second information to the first communication module 230 of the electronic device 101 according to out-band communication.

In operation 621, the first communication module 230 may transfer, to the first processor 260, the second information received from the second communication module 235.

In operation 623, the first processor 260 may determine, based on the second information, whether misalignment occurs. According to an embodiment, the first processor 260 may compare the second information (e.g., charging efficiency calculated by the external device 201) obtained from the external device 201 according to out-band communication and the charging efficiency (e.g., reference charging efficiency) set for the electronic device 101, and may determine whether misalignment occurs based on a result of the comparison. According to an embodiment, based on a difference between the calculated charging efficiency and the reference charging efficiency, the first processor 260 may determine whether alignment or misalignment occurs. For example, in the case that the calculated charging efficiency is approximately 80% and the reference charging efficiency is approximately 80%, the first processor 260 may determine that it is an optimal alignment state. As another example, in the case that the calculated charging efficiency is approximately 60% and the reference charging efficiency is approximately 80%, the electronic device 101 may determine that it is a misalignment state.

In operation 625, the first processor 260 may provide a notification based on a result of the determination. According to an embodiment, based on the determination indicating that alignment occurs, the first processor 260 may provide a guide notification related to wireless charging (e.g., information related to a charging state or level) via an output module (e.g., the output module 240 of FIG. 2). According to another embodiment, based on determination indicating that misalignment occurs, the first processor 260 may provide an alignment notification related to location alignment (e.g., information related to a misalignment state or warning) via an output module (e.g., the output module 240 of FIG. 2).

According to various embodiments of the disclosure, after the second communication channel is established between the electronic device 101 and the external device 201, the electronic device 101 may periodically transmit first information (e.g., control data such as a CEP and/or an RPP) by using the wireless power reception circuit 210 via the first communication channel to the wireless power transmission circuit 215 of the external device 201. According to an embodiment, based on the first information transmitted via the first communication channel, the external device 201 may identify a state of a connection to the electronic device 101 and a charging state.

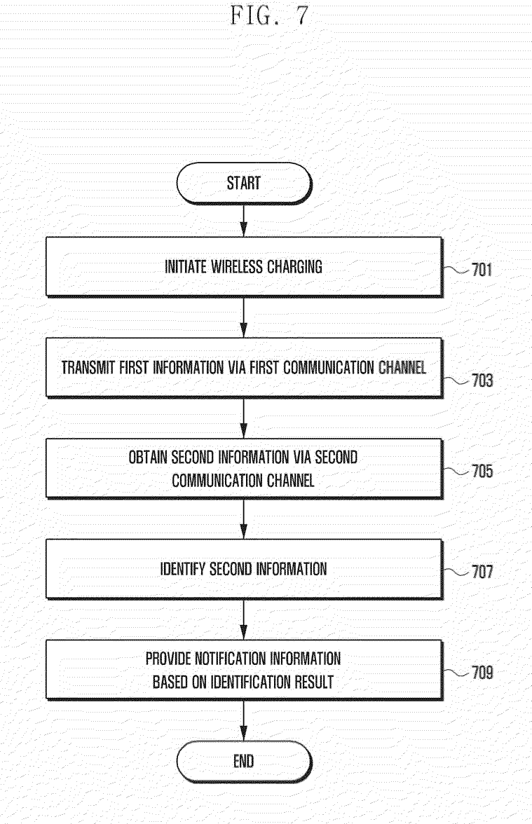

FIG. 7 is a flowchart illustrating an operation method of an electronic device according to various embodiments.

Referring to FIG. 7, in operation 701, a processor (e.g., the first processor 260 of FIG. 2, FIG. 3, or FIG. 6) of the electronic device 101 may initiate wireless charging. According to an embodiment, the processor 260 may establish, via the wireless power reception circuit 210, a first communication channel (e.g., the first communication channel 280 of FIG. 2 or FIG. 3) with the wireless power transmission circuit 215 of the external device 201. According to an embodiment, the processor 260 may receive wireless power from the external device 201 via the first communication channel, and may charge a battery (e.g., the first battery 220 of FIG. 2).

In operation 703, the processor 260 may transmit first information to the external device 201 via the first communication channel. According to an embodiment, the processor 260 may determine an RPP and/or a CEP based on power (e.g., voltage value and/or power value information) received from the external device 201 via the first communication channel, and may produce first information based on the determined RPP and/or CEP. According to an embodiment, the processor 260 may transmit the produced first information to the external device 201 via the first communication channel. According to an embodiment, the processor 260 may further include an operation of activating a communication module (e.g., the first communication module 230 of FIG. 2, FIG. 3, or FIG. 6) based on the state (e.g., an inactive state) of the communication module for establishing a second communication channel in the case of initiating wireless charging or transmitting the first information. According to an embodiment, the processor 260 may include an operation of activating the communication module and establishing the second communication channel for out-band communication with the external device 201 in the case of initiating wireless charging or transmitting the first information.

In operation 705, the processor 260 may receive second information from the external device 201 via the second communication channel different from the first communication channel. According to an embodiment, the second information may include information related to charging efficiency of the electronic device 101 calculated by the external device 201. For example, the second information may include information associated with substantial charging efficiency of the electronic device 101, calculated by the external device 201 in consideration of both the reception power of the electronic device 101 and the transmission power of the external device 201.

In operation 707, the processor 260 may identify the received second information. According to an embodiment, based on the second information, the processor 260 may determine substantial charging efficiency of the electronic device 101. According to an embodiment, the processor 260 may compare the second information received from the external device 201 and the charging efficiency (e.g., reference charging efficiency) set for the electronic device 101, and may determine whether misalignment occurs based on a result of the comparison. For example, based on a difference between the charging efficiency based on the second information and the reference charging efficiency, the processor 260 may determine whether alignment or misalignment occurs.

In operation 709, based on a result of the identification, the first processor 260 may provide notification information. According to an embodiment, based on the determination indicating that alignment occurs, the processor 260 may provide a guide notification related to wireless charging (e.g., information related to a charging state or level) via an output module (e.g., the output module 240 of FIG. 2). According to another embodiment, based on determination indicating that misalignment occurs, the processor 260 may provide an alignment notification related to location alignment (e.g., information related to a misalignment state or warning) via an output module (e.g., the output module 240 of FIG. 2). According to an embodiment, the notification information may be provided visibly, audibly, and/or tactually depending on an output module.

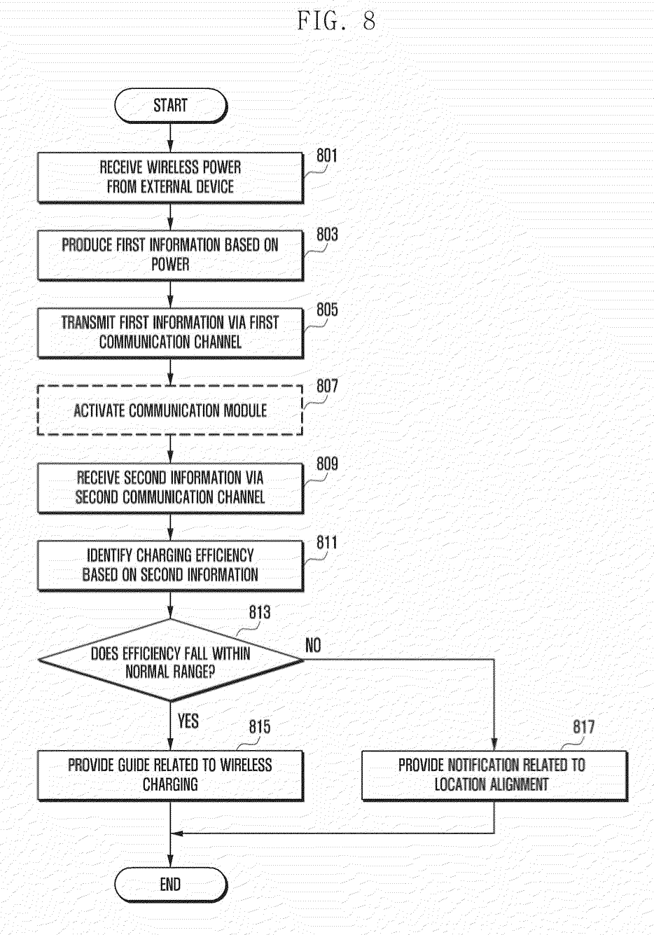

FIG. 8 is a flowchart illustrating an operation method of an electronic device according to various embodiments.

Referring to FIG. 8, in operation 801, a processor (e.g., the first processor 260 of FIG. 2, FIG. 3, or FIG. 6) of the electronic device 101 may receive wireless power from the external device 201. According to an embodiment, the processor 260 may receive wireless power from the external device 201 by using the wireless power reception circuit 210 via a first communication channel (e.g., the first communication channel 280 of FIG. 2 or FIG. 3) for in-band communication with the wireless power transmission circuit 215 of the external device 201, and may charge a battery (e.g., the first battery 220 of FIG. 2).

In operation 803, based on power received from the external device 201, the processor 260 may produce first information (e.g., an RPP and/or a CEP). According to an embodiment, the processor 260 may determine an RPP and/or a CEP based on power (e.g., voltage value and/or power value information) received from the external device 201 via the first communication channel, and may produce first information based on the determined RPP and/or CEP.

In operation 805, the processor 260 may transmit the first information to the external device 201 via the first communication channel.

In operation 807, based on a state (e.g., an inactive state) of a communication module (e.g., the first communication module 230 of FIG. 2, FIG. 3, or FIG. 6), the processor 260 may activate a communication module. According to an embodiment, the processor 260 may include an operation of activating the communication module and establishing a second communication channel for out-band communication with the external device 201 in the case of initiating wireless charging or transmitting the first information. According to an embodiment, in the case that a second communication channel is established in advance between the electronic device 101 and the external device 201, operation 807 may not be performed and omitted. According to an embodiment, in the case of activating a communication module, the processor 260 may search for the external device 201 connectable using out-band (e.g., Bluetooth, BLE, NFC, and/or Wi-Fi) communication. According to an embodiment, the processor 260 may periodically perform BLE scanning via the communication module, and may receive, based on the BLE scanning, a BLE advertisement of the external device 201.

In operation 809, the processor 260 may receive second information from the external device 201 via the second communication channel different from the first communication channel. According to an embodiment, the second information may include information related to charging efficiency of the electronic device 101 calculated by the external device 201. For example, the second information may include information associated with substantial charging efficiency of the external device 201 calculated in consideration of both the transmission power of the electronic device 101 and the reception power of the external device 201.

In operation 811, based on the second information, the processor 260 may identify substantial charging efficiency of the electronic device 101. According to an embodiment, the processor 260 may compare charging efficiency based on the second information received from the external device 201 (e.g., charging efficiency calculated by the external device 201) and the charging efficiency (e.g., reference charging efficiency) set for the electronic device 101, and may determine a difference therebetween.

In operation 813, the processor 260 may determine, based on a result of the identification, whether the charging efficiency falls within a normal range. According to an embodiment, the processor 260 may identify whether the difference between the calculated charging efficiency and the set charging efficiency is present. For example, the processor 260 may determine that the charging efficiency falls within the normal range if the difference in charging efficiency is not present, and may determine that the charging efficiency is beyond the normal range if the difference in charging efficiency is present. For example, based on whether the difference in charging efficiency is present, the processor 260 may determine whether misalignment occurs.

In operation 813, in the case that the charging efficiency is determined as falling within the normal range (e.g., ‘YES’ in operation 813), the processor 260 may provide (e.g., display) a guide related to wireless charging via an output module (e.g., the output module 240 of FIG. 2) in operation 815. According to an embodiment, in the case that the charging efficiency is determined as falling within the normal range, the processor 260 may determine that locations in which the electronic device 101 and the external device 201 are disposed to close to each other is in optimal alignment, and may provide, based on the determination indicating that alignment occurs, a guide notification (information associated with a charging state or level) related to wireless charging via an output module.

In operation 813, in the case that the charging efficiency is determined as being beyond the normal range (e.g., ‘NO’ in operation 813), the processor 260 may provide (e.g., display) a notification related to location alignment via an output module (e.g., the output module 240 of FIG. 2) in operation 817. According to an embodiment, in the case that the charging efficiency is determined as being beyond the normal range, the processor 260 may determine that locations in which the electronic device 101 and the external device 201 are disposed to close to each other are in misalignment, and may provide, based on the determination indicating that misalignment occurs, an alignment notification (information related to a misalignment state or warning) related to location alignment via an output module.

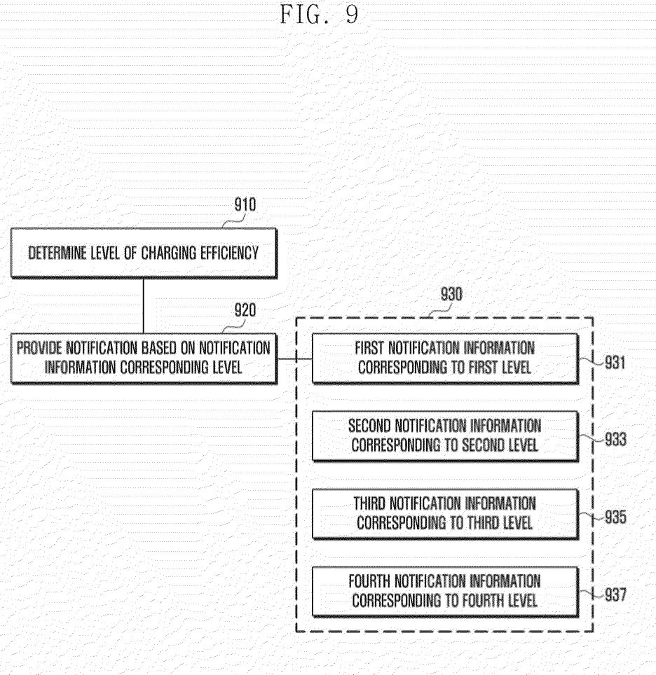

FIG. 9 is a diagram illustrating an example of providing a notification by an electronic device according to various embodiments.

As illustrated in FIG. 9, according to various embodiments, the electronic device 101 may distinguish alignment and misalignment in different levels based on the degree of a difference between charging efficiency obtained from the external device 201 (e.g., charging efficiency calculated by the external device 201 and obtained according to out-band communication) and reference charging efficiency (e.g., reference charging efficiency set for the electronic device 101). For example, the electronic device 101 may distinguish charging efficiency in predetermined levels (e.g., 4 levels in the example of FIG. 9) and may provide a different notification for each level.

Referring to FIG. 9, in operation 910, the electronic device 101 may determine a level of charging efficiency. According an embodiment, the electronic device 101 may determine whether a difference between the obtained charging efficiency and the reference charging efficiency corresponds to level 1, level 2, level 3, or level 4. For example, if there is little difference and the difference falls within a first range (e.g., a range of approximately 0% to approximately 0.9%) such as the case in which the obtained charging efficiency is approximately 80% and the reference charging efficiency is approximately 80%, the electronic device 101 may determine that charging efficiency is in level 1 and corresponds to an optimal alignment state. As another example, if the difference falls within a second range (e.g., a range of approximately 1% to approximately 10%) such as the case in which the calculated charging efficiency is approximately 70% and the reference charging efficiency is approximately 80%, the electronic device 101 may determine that charging efficiency is in level 2 and corresponds to a misalignment state. As another example, if the difference falls within a third range (e.g., a range of approximately 11% to approximately 20%) such as the case in which the calculated charging efficiency is approximately 60% and the reference charging efficiency is approximately 80%, the electronic device 101 may determine that charging efficiency is in level 3 and corresponds to a misalignment state. As another example, if the difference falls within a fourth range (e.g., approximately 21% or higher) such as the case in which the calculated charging efficiency is approximately 50% and the reference charging efficiency is approximately 80%, the electronic device 101 may determine that charging efficiency is in level 4 and corresponds to a misalignment state. According to various embodiments, based on the degree of a difference between the obtained charging efficiency and the reference charging efficiency, the electronic device 101 may distinguish misalignment in different levels.

In operation 920, based on notification information 930 corresponding to the determined level, the electronic device 101 may provide a notification. According to an embodiment, the electronic device 101 may map the notification information 930 for each level and may store the same in a memory (e.g., the first memory 250 of FIG. 2). For example, the electronic device 101 may store first notification information 931 corresponding to level 1, second notification information 933 corresponding to level 2, third notification information 935 corresponding to level 3, and fourth notification information 937 corresponding to level 4 in the form of a lookup table in the memory 250. According to an embodiment, the notification information 930 may be visible, audible, and/or tactual information capable of providing a notification differently according to each corresponding level, and may be embodied as a charging state, misalignment, and/or various types of information that enables a user to easily recognize (or distinguish) misalignment.

According to various embodiments, using a notification for each level, guidance may be provided so that a user may easily find out a location that provides optimal charging efficiency. According to various embodiments, by calculating substantial charging efficiency in consideration of the efficiency of the electronic device 101 and the efficiency of the external device 201, a guide associated with misalignment may be provided in the electronic device 101, and optimal charging efficiency may be provided to the electronic device 101 while battery consumption by the external device 201 is reduced. According to various embodiments, according to a guide for each level of misalignment, an accurate (detailed) positioning guide may be provided to a user.

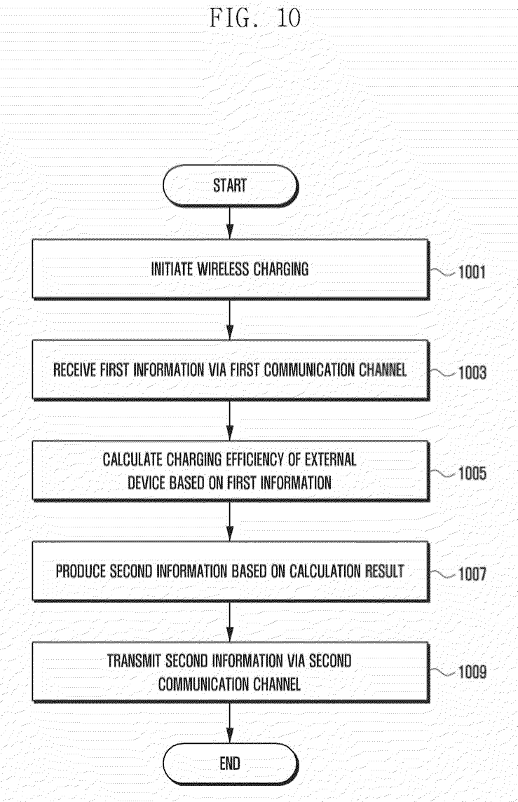

FIG. 10 is a flowchart illustrating an operation method of an external device according to various embodiments.

Referring to FIG. 10, in operation 1001, a processor (e.g., the second processor 265 of FIG. 2, FIG. 3, or FIG. 6) of the external device 201 may initiate wireless charging. According to an embodiment, the processor 265 may establish, via the wireless power transmission circuit 215, a first communication channel (e.g., the first communication channel 280 of FIG. 2 or FIG. 3) with the wireless power reception circuit 210 of the electronic device 101. According to an embodiment, the processor 265 may transmit (or share) wireless power to the electronic device 201 via the first communication channel.

In operation 1003, the processor 265 may receive first information from the electronic device 101 via the first communication channel. According to an embodiment, the first information may include information related to an RPP and/or a CEP. According to an embodiment, the processor 265 may further include an operation of activating a communication module based on the state (e.g., an inactive state) of the communication module (e.g., the second communication module 235 of FIG. 2, FIG. 3, or FIG. 6) for establishing a second communication channel in the case of initiating wireless charging or receiving the first information. According to an embodiment, the processor 265 may include an operation of activating the communication module and establishing the second communication channel for out-band communication with the electronic device 101 in the case of initiating wireless charging or receiving the first information.

In operation 1005, the processor 265 may calculate charging efficiency of the electronic device 101. According to an embodiment, using the transmission power (e.g., the magnitude of power) that the external device 201 transmits via the wireless power transmission circuit 215 and the first information (e.g., a CEP and/or an RPP) obtained from the electronic device 101 according to in-band communication, the processor 265 may calculate charging efficiency of the electronic device 101. For example, based on the transmission power of the external device 201 and the reception power of the electronic device 101, the processor 265 may calculate substantial charging efficiency in consideration of the external device 201 and the electronic device 101 as given in Equation 1.

In operation 1007, the processor 265 may produce, based on a result of the calculation, second information (e.g., substantial charging efficiency in consideration of the electronic device 101 and the external device 201).

In operation 1009, the processor 265 may transmit the second information to the electronic device 101 via a second communication channel different from the first communication channel. According to an embodiment, the second information may include information related to charging efficiency of the electronic device 101 calculated by the external device 201. For example, the second information may include information associated with substantial charging efficiency of the external device 201 calculated by the external device 201 in consideration of both the transmission power of the electronic device 101 and the reception power of the external device 201.

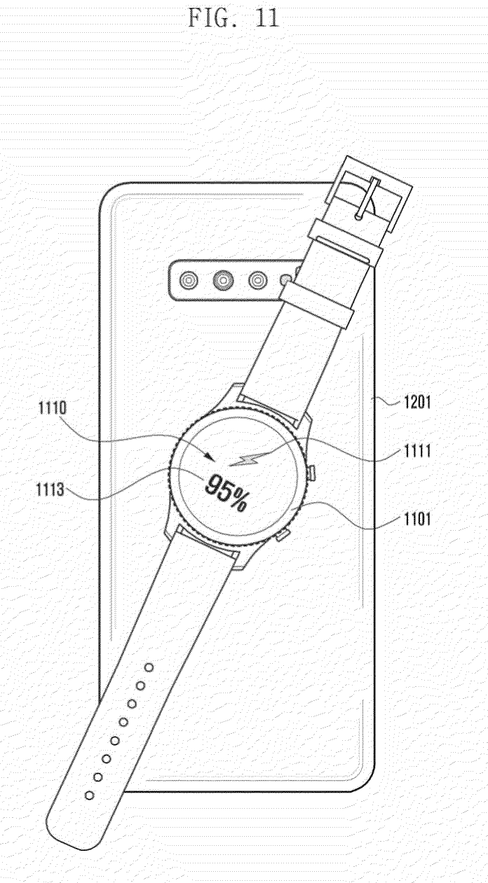

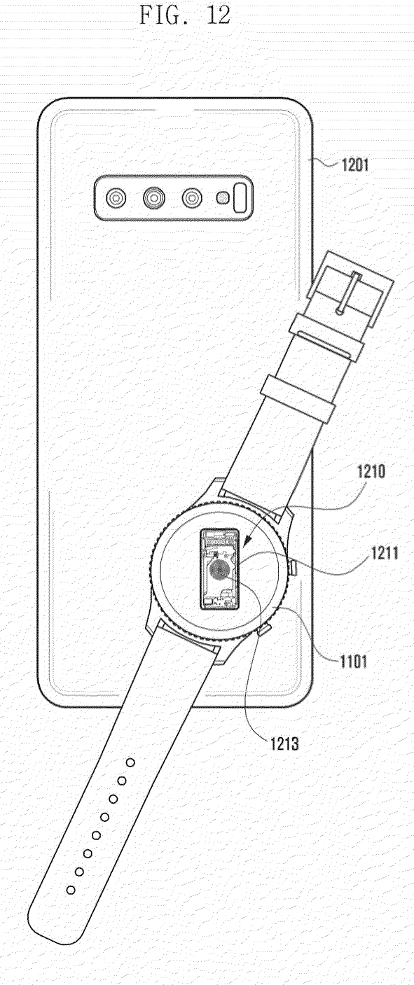

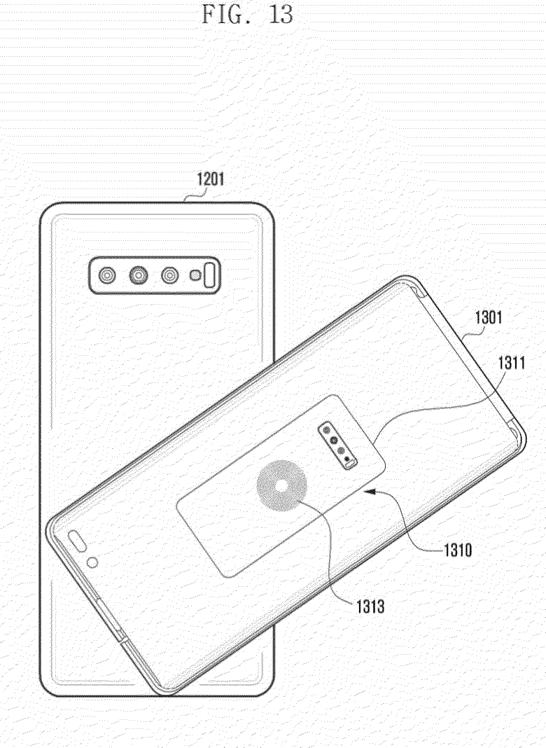

FIG. 11, FIG. 12, and FIG. 13 are diagrams illustrating an example of providing a notification and a charging operation performed between an electronic device and an external device according to an embodiment.

According to an embodiment, FIGS. 11, 12, and 13 illustrate examples of a user’s scenario that charges the electronic device 101 in a wireless manner using a wireless charging function of an external device 1201.

According to an embodiment, in the examples of FIG. 11 and FIG. 12, the external device 201 that transmits (or shares) wireless power is the smartphone 1201, and the electronic device 101 that receives wireless power and charge a battery is a wearable device 1101 (e.g., a smart watch). According to an embodiment, in the example of FIG. 13, the external device 201 that transmits (or shares) wireless power is the smartphone 1201, and the electronic device 101 that receives wireless power and charge a battery is a smartphone 1301. According to an embodiment, although FIGS. 11, 12, and 13 illustrate the external device 201 and the electronic device 101 as predetermined devices, the external device 201 that transmits wireless power may include a charging pad, and the electronic device 101 that receives wireless power may include various types of electronic devices (e.g., wireless earphones, a wireless headset, and/or smart glasses) capable of receiving power from another electronic device (e.g., the external device 1201) and performing wireless charging.

Referring to FIG. 11 and FIG. 12, for wireless charging, the electronic device 1101 (e.g., the electronic device 101 of FIG. 2, FIG. 3, or FIG. 6) may be disposed on the rear side of the external device 1201 (e.g., the external device 201 of FIG. 2, FIG. 3, or FIG. 6) so that the rear side of the electronic device 1101 in which a charging coil of the electronic device 1101 is disposed faces the rear side of the external device 1201 in which the charging coil of the external device 1201 is disposed.

According to an embodiment, based on a user input, the external device 1201 may activate a wireless power transmission mode (e.g., a wireless battery sharing mode), and when the wireless power transmission mode is activated, the external device 1201 may supply power to the electronic device 1101 in a wireless manner using power of a battery (e.g., the second battery 225 of FIG. 2). According to an embodiment, a user input may include a user touch input provided on a display module (e.g., the display module 160 of FIG. 1), operating a physical button formed on the exterior of a housing (not illustrated), or an approach of the electronic device 1101 to the external device 1201. According to an embodiment, in the case that a wired power supply device (not illustrated) (or an external power source device) (e.g., TA) is connected, the external device 1201 may receive power from the wired power supply device and may provide power to the electronic device 1101 and simultaneously (or parallelly), may charge the second battery 225 of the external device 1201.

According to an embodiment, as illustrated in FIG. 11, in the case that the wireless power transmission mode is activated in a stand-alone state, the external device 1201 may produce designated power (e.g., approximately 5 V/3.75 W) using power of the second battery 225, and may transmit the designated power to the electronic device 101 via a coil (e.g., the coil 340 of FIG. 3). For example, the stand-alone state may be a state in which the external device 1201 is not connected to a wired power supply device.

According to an embodiment, in the case that the wireless power transmission mode is activated, the external device 1201 may perform in-band communication with the electronic device 1101 according to a designated standard (e.g., the WPC standard), and may exchange, with the electronic device 1101, information needed for wireless power transmission. For example, wireless charging according to the WPC standard may include a ping operation, an identification and configuration operation, or a power transfer operation. According to an embodiment, the ping operation is an operation that determines whether the electronic device 1101 that is a wireless power reception device is placed on the external device 1201, for example, an operation that determines whether the external device 1201 is close to the electronic device 1101. According to an embodiment, the identification and configuration operation is an operation that sets the amount of power to be transmitted via communication between the external device 1201 that is a wireless power supply device and the electronic device 1101 that is a wireless power reception device, for example, an operation that determines designated wireless power to be transmitted from the external device 1201 to the electronic device 1101. According to an embodiment, the power transmission operation is an operation that transmits the designated wireless power, for example, an operation that transmits the designated wireless power from the external device 1201 to the electronic device 1101. According to an embodiment, when the wireless power transmission mode is activated, the external device 1201 may perform the three above-described operations and may transmit wireless power. When the wireless power transmission mode is inactivated, the three operations may not be performed.

According to an embodiment, in the case that the wireless power transmission mode is in an active state, the external device 1201 may perform a designated operation based on a designated event. According to an embodiment, the designated event may include inactivation of a wireless power transmission mode, the second battery 225 being discharged to be less than or equal to a designated level (e.g., having a state of charge (SOC) less than N %, for example, less than 15%, 20%, or 30%), the electronic device 1101 being fully charged, or the electronic device 1101 deviating from a state of being in close contact (e.g., a CEP not being received during a predetermined period of time). According to an embodiment, based on detection of a designated event, the external device 1201 may suspend an operation of transmitting designated power to the electronic device 1101 (e.g., inactivation of a wireless power transmission mode).

According to an embodiment, as illustrated in FIG. 11, in the case that the electronic device 1101 is placed on a designated location of the external device 1201 in an optimal alignment state, the electronic device 1101 may provide a guide notification 1110 (e.g., information associated with a charging state or level) related to wireless charging via an output module (e.g., the output module 240 of FIG. 2). For example, as illustrated in FIG. 11, the electronic device 101 may provide a first object 1111 (e.g., text and/or an icon) indicating that charging is in progress and a second object 1113 (e.g., text and/or an icon) indicating a charging level (e.g., a charging capacity) via a display module (e.g., the display module 160 of FIG. 1).

According to an embodiment, as illustrated in FIG. 12, in the case that the electronic device 1101 is placed on a location (e.g., a lower part area) different from the designated location of the external device 1201 in a misalignment state, the electronic device 1101 may provide an alignment notification 1210 (e.g., information related to a misalignment state or warning) related to location alignment via an output module (e.g., the output module 240 of FIG. 2). For example, as illustrated in FIG. 12, the electronic device 1101 may provide, via a display module (e.g., the display module 160 of FIG. 1), various objects to provide guidance to enable the electronic device 1101 to change (or realign) its location since misalignment occurs. According to an embodiment, the electronic device 101 may provide location information 1210 indicating a location where a transmission coil is disposed in the direction of the rear side of the external device 1201. For example, the electronic device 1101 provides an image 1213 (or a fourth object) (e.g., an image corresponding to a coil) indicating a location for charging on an image 1211 (or a third object) corresponding to the external device 1201, so as to guide a user to the location of a coil on the actual external device 1201, and thus the user may easily find out a location that provides optimal charging efficiency. According to an embodiment, the electronic device 101 may provide text set for misalignment so as to provide guidance to enable the electronic device 101 to change its location.

According to an embodiment, based on charging efficiency obtained from the external device 201 according to out-band communication, the electronic device 1101 may identify substantial charging efficiency that is different from charging efficiency set for the electronic device 101, and may determine whether misalignment occurs based on a result of the identification. According to an embodiment, if it is determined that misalignment occurs, the electronic device 1101 may provide a guide for a location for alignment differently based on the notification information 930 based on the level of charging efficiency. For example, based on the second notification information 933 corresponding to level 2, the electronic device 101 may provide a notification corresponding to warning level 1 (e.g., provide a visible, audible, or tactual output having relatively weak strength (or intensity)). As another example, based on the third notification information 935 corresponding to level 3, the electronic device 101 may provide a notification corresponding to warning level 2 (e.g., provide a visible, audible, or tactual output having a relatively medium strength (or intensity)). As another example, based on the fourth notification information 937 corresponding to level 4, the electronic device 101 may provide a notification corresponding to warning level 3 (e.g., provide a visible, audible, or tactual output having relatively strong strength (or intensity)). For example, the guide for a location for alignment may differ depending on setting of the electronic device 101 or the type of information included in notification information, and may be changed variously. According to an embodiment, the electronic device 1101 may additionally provide at least one of a location indicator indicating where the electronic device 1101 is located in the direction of the rear side of the external device 1201, a coil direction indicator indicating a direction in which a transmission coil is located, a guide area indicating an area where a transmission coil is disposed, and/or a guide indicator indicating movement to an area where a transmission coil is disposed.

According to an embodiment, based on the notification 1210 provided by the electronic device 1101, a user may move the electronic device 1101 in a direction in which a charging coil of the external device 1201 is disposed. For example, as illustrated in FIG. 11, the user may match the location of the charging coil of the electronic device 1101 and the location of the charging coil of the external device 1201. According to an embodiment, in the case that the charging coil of the external device 1201 and the charging coil of the electronic device 1101 are aligned, the electronic device 101 may provide the guide notification 1110 via an object (e.g., the first object 1111) indicating that a battery is being charged and a battery charging level object (e.g., a second object 1113) as illustrated in FIG. 11.

Referring to FIG. 13, the external device 1201 according to an embodiment and an electronic device 1301 may be placed in locations close to each other for wireless charging, for example, the electronic device 1301 may be disposed on the rear side of the electronic device 1201 so that rear side in which a charging coil of the electronic device 1301 face the rear side in which the charging coil of the external device 1201. According to an embodiment, an operation of initiating wireless charging between the external device 1201 and the electronic device 1301 may correspond to the descriptions provided with reference to FIG. 11 and FIG. 12, and detailed descriptions thereof will be omitted.

According to an embodiment, as illustrated in FIG. 13, in the case that the electronic device 1301 is placed on a location (e.g., a lower part area) different from a designated location of the external device 1201 in a misalignment state, the electronic device 1301 may provide an alignment notification 1310 (e.g., information related to a misalignment state or warning) related to location alignment via an output module (e.g., the output module 240 of FIG. 2). For example, the electronic device 1301 may provide location information 1310 (e.g., a third object 1311, a fourth object 1313) that corresponds to the descriptions provided with reference to the location information 1210 in FIG. 12, and detailed descriptions thereof will be omitted.

According to various embodiments, the electronic device 101 and the external device 201 may have different charging efficiency depending on a location of alignment. For example, if the location of the center of a transmission coil of the external device 201 and the location of the center of a reception coil of the electronic device 101 are beyond a reference range (e.g., the locations thereof are not aligned or in a misalignment state), charging efficiency may deteriorate. According to an embodiment, as illustrated in FIG. 12 or FIG. 13, in the case that the electronic device 101 is place in a lower part area of the external device 201, the electronic device 101 may identify that the locations thereof are not aligned (or in a misalignment state) based on charging efficiency obtained via out-band communication, and may provide corresponding guide information to a user.

Embodiments of the disclosure disclosed in the specification and the accompanying drawings are merely examples for describing the technical contents of the disclosure and helping understanding of the disclosure, but the scope of the disclosure is not limited thereto. Therefore, it should be construed that the scope of the disclosure includes all modifications or modified forms obtained based on the technical idea of the disclosure, in addition to the embodiments disclosed herein.

What is claimed is:

1. An electronic device comprising:
a wireless power reception circuit;
a communicator; and
at least one processor operatively connected to the wireless power reception circuit and the communicator,
wherein the at least one processor is configured to:
control, based on initiation of wireless charging of the electronic device, power input from an external device to the electronic device via the wireless power reception circuit;
transmit, to the external device via a designated communication scheme, first information corresponding to the power input to the electronic device from the external device;
receive, from the external device via an out-band communication scheme through the communicator, second information that corresponds to a charging efficiency of the electronic device; and
provide, based on the second information, a location change notification for the electronic device.

2. The electronic device of claim 1, wherein the at least one processor is further configured to:
produce, based on the power input from the external device, the first information related to charging,
wherein the designated communication scheme comprises an in-band communication scheme or the out-band communication scheme, and
wherein the first information comprises control data corresponding to at least one of a received power packet (RPP) or a control error packet (CEP).

3. The electronic device of claim 1, wherein the at least one processor is further configured to:
activate, based on a state of the communicator, the communicator when initiating the wireless charging or transmitting the first information; and
establish, via the communicator, a communication channel for the out-band communication scheme with the external device.

4. The electronic device of claim 1, wherein the second information comprises the charging efficiency of the electronic device, the second information is determined by the external device, and
wherein the second information is based on a ratio of power received by the electronic device to power transmitted by the external device.

5. The electronic device of claim 4, wherein the power received by the electronic device is identified based on the first information.

6. The electronic device of claim 1, wherein the at least one processor is further configured to:
compare a first charging efficiency based on the second information and a second charging efficiency set for the electronic device; and
based on a difference between the first charging efficiency and the second charging efficiency, determine whether alignment or misalignment occurs.

7. The electronic device of claim 6, wherein the at least one processor is further configured to:
based on determining that alignment occurs, provide a first guide related to wireless charging; and
based on determining that misalignment occurs, provide a second guide related to location alignment.

8. The electronic device of claim 6, wherein the at least one processor is further configured to:
based on determining that misalignment occurs, provide a notification for a degree of misalignment corresponding to a degree of the difference between the first charging efficiency and the second charging efficiency.

9. The electronic device of claim 6, wherein the at least one processor is configured to:
determine, based on the difference between the first charging efficiency and the second charging efficiency, whether the first charging efficiency is within a predetermined range;
based on determining that the first charging efficiency is within the predetermined range, determine that alignment occurs and provide a notification related to wireless charging via an output module of the electronic device; and
based on determining that the first charging efficiency is outside of the predetermined range, determine that misalignment occurs and provide the location change notification via the output module.

10. The electronic device of claim 2, wherein the in-band communication scheme comprises communication via a wireless power signal between a coil of the electronic device and a coil of the external device, and
wherein the out-band communication scheme comprises a short-range wireless communication scheme different from the in-band communication scheme.

11. An operation method of an electronic device, the operation method comprising:
receiving, based on initiation of wireless charging of the electronic device, power from an external device via a wireless power reception circuit;
transmitting, to the external device via a designated communication scheme, first information corresponding to the power received by the electronic device from the external device;
receiving, from the external device via an out-band communication scheme using a communicator of the electronic device, second information corresponding to a charging efficiency of the electronic device; and
providing, based on the second information, a location change notification for the electronic device.

12. The operation method of claim 11, further comprising:
producing, based on the power received from the external device, the first information related to charging,
wherein the designated communication scheme comprises an in-band communication scheme or the out-band communication scheme, and
wherein the first information comprises control data corresponding to a received power packet (RPP) or a control error packet (CEP).

13. The operation method of claim 12, further comprising:
activating, based on a state of the communicator, the communicator when initiating the wireless charging or transmitting the first information; and
establishing, via the communicator, a communication channel for the out-band communication scheme with the external device.

14. The operation method of claim 11, wherein the second information comprises the charging efficiency of the electronic device,
wherein the second information is determined by the external device, and
wherein the second information is based on a ratio of power received by the electronic device to power transmitted from the external device.

15. The operation method of claim 14, wherein the power received by the electronic device is identified based on the first information.

16. The operation method of claim 11, wherein the providing the location change notification comprises:
comparing a first charging efficiency based on the second information and a second charging efficiency set for the electronic device; and
determining, based on a difference between the first charging efficiency and the second charging efficiency, whether alignment or misalignment occurs.

17. The operation method of claim 16, wherein the providing the location change notification comprises:
based on determining that alignment occurs, providing a first guide related to wireless charging; and
based on determining that misalignment occurs, providing a second guide related to location alignment.

18. The operation method of claim 17, wherein the providing the location change notification further comprises:
based on determining that misalignment occurs, providing a notification for a degree of misalignment corresponding to a degree of the difference between the first charging efficiency and the second charging efficiency.

19. The operation method of claim 17, wherein the providing the location change notification further comprises:
determining, based on the difference between the first charging efficiency and the second charging efficiency, whether the first charging efficiency is within a predetermined range;
based on determining that the first charging efficiency is within the predetermined range, determining that alignment occurs and providing a notification related to wireless charging via an output module of the electronic device; and
based on determining that the first charging efficiency is outside of the predetermined range, determining that misalignment occurs and providing the location change notification via the output module.

20. The operation method of claim 11,
wherein the in-band communication scheme comprises communication via a wireless power signal between a coil of the electronic device and a coil of the external device, and
wherein the out-band communication scheme comprises a short-range wireless communication scheme different from the in-band communication scheme.
